(19) United States
(12) Patent Application Publication
(10) Pub. No.: US 2024/0243849 A1
(43) Pub. Date: Jul. 18, 2024

(54) FEEDBACK PROCESSES FOR ENERGY HARVESTING DEVICES

(71) Applicant: QUALCOMM Incorporated, San Diego, CA (US)

(72) Inventors: Ahmed Elshafie, San Diego, CA (US); Wei Yang, San Diego, CA (US); Huilin Xu, Temecula, CA (US); Linhai He, San Diego, CA (US); Yuchul Kim, San Diego, CA (US); Konstantinos Dimou, New York City, NY (US)

(21) Appl. No.: 18/154,773

(22) Filed: Jan. 13, 2023

(51) Int. Cl. H04L 1/1812; H04L 1/1829

(52) U.S. Cl. CPC H04L 1/1812; H04L 1/1848

(57) ABSTRACT

Methods, systems, and devices for wireless communications are described. An energy harvesting device may transmit energy status information for the energy harvesting device, where the energy harvesting device may cycle between an energy harvesting mode and a wireless communication mode. During the wireless communication mode, the energy harvesting device may receive control signaling indicating to apply a first feedback process type (e.g., a hybrid automatic repeat request (HARQ) process) of multiple different feedback process types based on the energy status information. The energy harvesting device may receive a control message scheduling transmission of a message to the energy harvesting wireless device in a resource of a shared data channel. Accordingly, the energy harvesting device may monitor the resource for the message based on the control message and may transmit feedback information for the message in accordance with the indicated feedback process type.

### FIELD OF TECHNOLOGY

The present disclosure relates to wireless communications, including feedback processes for energy harvesting devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, an energy harvesting device may cycle between a wireless communication mode and an energy harvesting mode to generate and store energy at the energy harvesting device for wireless communications activities. In some examples, the energy harvesting device may lose power or enter an energy harvesting mode during a feedback process, which may impact reliability of communications at the energy harvesting device.

### SUMMARY

The described techniques relate to improved methods, systems, devices, and apparatuses that support feedback processes for energy harvesting devices. For example, the described techniques provide for an energy harvesting device indicating energy status information of the energy harvesting device and dynamically modifying a feedback process type for a message based on the energy status information. For instance, the feedback process type may include modified timers associated with a feedback procedure for the message. In some examples, the feedback process type may indicate a quantity of hybrid automatic repeat request (HARQ) processes for the message based on the energy status information or may indicate automatic repeat request (ARQ) processes as opposed to HARQ processes based on the energy status information. The energy harvesting device may receive control signaling indicating which feedback process type to use and may perform feedback for the message based on the indicated feedback process type.

A method for wireless communication at an energy harvesting wireless device is described. The method may include transmitting energy status information for the energy harvesting wireless device, where the energy harvesting wireless device cycles between an energy harvesting mode and a wireless communication mode, receiving, during the wireless communication mode, control signaling indicating to apply a first feedback process type of a set of multiple different feedback process types based on the energy status information, receiving a control message scheduling transmission of a message to the energy harvesting wireless device in a resource of a shared data channel, monitoring the resource for the message based on the control message, and transmitting feedback information for the message in accordance with the indicated first feedback process type.

An apparatus for wireless communication at an energy harvesting wireless device is described. The apparatus may include a processor, memory coupled with the processor, and instructions stored in the memory. The instructions may be executable by the processor to cause the apparatus to transmit energy status information for the energy harvesting wireless device, where the energy harvesting wireless device cycles between an energy harvesting mode and a wireless communication mode, receive, during the wireless communication mode, control signaling indicating to apply a first feedback process type of a set of multiple different feedback process types based on the energy status information, receive a control message scheduling transmission of a message to the energy harvesting wireless device in a resource of a shared data channel, monitor the resource for the message based on the control message, and transmit feedback information for the message in accordance with the indicated first feedback process type.

Another apparatus for wireless communication at an energy harvesting wireless device is described. The apparatus may include means for transmitting energy status information for the energy harvesting wireless device, where the energy harvesting wireless device cycles between an energy harvesting mode and a wireless communication mode, means for receiving, during the wireless communication mode, control signaling indicating to apply a first feedback process type of a set of multiple different feedback process types based on the energy status information, means for receiving a control message scheduling transmission of a message to the energy harvesting wireless device in a resource of a shared data channel, means for monitoring the resource for the message based on the control message, and means for transmitting feedback information for the message in accordance with the indicated first feedback process type.

A non-transitory computer-readable medium storing code for wireless communication at an energy harvesting wireless device is described. The code may include instructions executable by a processor to transmit energy status information for the energy harvesting wireless device, where the energy harvesting wireless device cycles between an energy harvesting mode and a wireless communication mode, receive, during the wireless communication mode, control signaling indicating to apply a first feedback process type of a set of multiple different feedback process types based on the energy status information, receive a control message scheduling transmission of a message to the energy harvesting wireless device in a resource of a shared data channel, monitor the resource for the message based on the control message, and transmit feedback information for the message in accordance with the indicated first feedback process type.

Some examples of the method, apparatuses, and non-transitory computer-readable medium described herein may further include operations, features, means, or instructions for transmitting updated energy status information for the energy harvesting wireless device and receiving the control signaling indicating to change from applying the first feedback process type to a second feedback process type based on the updated energy status information, where the first feedback process type includes a HARQ process and the second feedback process type includes an ARQ process.

Some examples of the method, apparatuses, and non-transitory computer-readable medium described herein may further include operations, features, means, or instructions for transmitting a report indicating a quantity of HARQ processes supported by the energy harvesting wireless device, where the quantity of HARQ processes indicates the first feedback process type.

In some examples of the method, apparatuses, and non-transitory computer-readable medium described herein, the report indicates a maximum quantity of HARQ processes.

Some examples of the method, apparatuses, and non-transitory computer-readable medium described herein may further include operations, features, means, or instructions for monitoring for a retransmission of the message based on an expiration of a round trip time (RTT) timer.

Some examples of the method, apparatuses, and non-transitory computer-readable medium described herein may further include operations, features, means, or instructions for receiving a low-power signal indicating a change to an RTT timer, a retransmission timer, or both.

Some examples of the method, apparatuses, and non-transitory computer-readable medium described herein may further include operations, features, means, or instructions for transmitting a message indicating a set of multiple RTT timers, where an RTT timer of the set of multiple RTT timers may be based on the energy status information.

Some examples of the method, apparatuses, and non-transitory computer-readable medium described herein may further include operations, features, means, or instructions for starting an RTT timer based on transmitting the feedback information, where a duration of the RTT timer may be based on the energy status information.

Some examples of the method, apparatuses, and non-transitory computer-readable medium described herein may further include operations, features, means, or instructions for monitoring a control channel for receiving a retransmission of the message during a duration of a retransmission timer, performing energy harvesting during the duration of the retransmission timer and based on entering an energy harvesting mode, and suspending the retransmission timer based on entering the energy harvesting mode.

In some examples of the method, apparatuses, and non-transitory computer-readable medium described herein, receiving the control signaling may include operations, features, means, or instructions for receiving the control signaling indicating a quantity of HARQ processes based on the energy status information.

Some examples of the method, apparatuses, and non-transitory computer-readable medium described herein may further include operations, features, means, or instructions for receiving a request to increase a quantity of HARQ processes based on the energy status information.

In some examples of the method, apparatuses, and non-transitory computer-readable medium described herein, the feedback information indicates one or more symbols of the message the energy harvesting wireless device failed to receive and the method, apparatuses, and non-transitory computer-readable medium may include further operations, features, means, or instructions for receiving a second control message that indicates a HARQ process and the one or more symbols based on the feedback information.

In some examples of the method, apparatuses, and non-transitory computer-readable medium described herein, receiving the second control message may include operations, features, means, or instructions for receiving the second control message that indicates a bitmap, where the bitmap indicates the one or more symbols.

In some examples of the method, apparatuses, and non-transitory computer-readable medium described herein, transmitting the energy status information may include operations, features, means, or instructions for transmitting the energy status information indicating that the energy harvesting wireless device corresponds to a class of wireless devices that support energy harvesting.

In some examples of the method, apparatuses, and non-transitory computer-readable medium described herein, the energy status information includes an energy status profile, a charging rate profile, a discharging rate profile, a battery leakage rate profile, or a combination thereof.

A method for wireless communication at a network node is described. The method may include receiving energy status information for an energy harvesting wireless device, where the energy harvesting wireless device cycles between an energy harvesting mode and a wireless communication mode, transmitting control signaling indicating to apply a first feedback process type of a set of multiple different feedback process types based on the energy status information, transmitting a control message scheduling transmission of a message to the energy harvesting wireless device in a resource of a shared data channel, transmitting the message based on the control message, and receiving feedback information for the message in accordance with the indicated first feedback process type.

An apparatus for wireless communication at a network node is described. The apparatus may include a processor, memory coupled with the processor, and instructions stored in the memory. The instructions may be executable by the processor to cause the apparatus to receive energy status information for an energy harvesting wireless device, where the energy harvesting wireless device cycles between an energy harvesting mode and a wireless communication mode, transmit control signaling indicating to apply a first feedback process type of a set of multiple different feedback process types based on the energy status information, transmit a control message scheduling transmission of a message to the energy harvesting wireless device in a resource of a shared data channel, transmit the message based on the control message, and receive feedback information for the message in accordance with the indicated first feedback process type.

Another apparatus for wireless communication at a network node is described. The apparatus may include means for receiving energy status information for an energy harvesting wireless device, where the energy harvesting wireless device cycles between an energy harvesting mode and a wireless communication mode, means for transmitting control signaling indicating to apply a first feedback process type of a set of multiple different feedback process types based on the energy status information, means for transmitting a control message scheduling transmission of a message to the energy harvesting wireless device in a resource of a shared data channel, means for transmitting the message based on the control message, and means for receiving feedback information for the message in accordance with the indicated first feedback process type.

A non-transitory computer-readable medium storing code for wireless communication at a network node is described. The code may include instructions executable by a processor to receive energy status information for an energy harvesting wireless device, where the energy harvesting wireless device cycles between an energy harvesting mode and a wireless communication mode, transmit control signaling indicating to apply a first feedback process type of a set of multiple different feedback process types based on the energy status information, transmit a control message scheduling transmission of a message to the energy harvesting wireless device in a resource of a shared data channel, transmit the message based on the control message, and receive feedback information for the message in accordance with the indicated first feedback process type.

Some examples of the method, apparatuses, and non-transitory computer-readable medium described herein may further include operations, features, means, or instructions for receiving updated energy status information for the energy harvesting wireless device and transmitting the control signaling indicating to change from applying the first feedback process type to a second feedback process type based on the updated energy status information, where the first feedback process type includes a HARQ process and the second feedback process type includes an ARQ process.

Some examples of the method, apparatuses, and non-transitory computer-readable medium described herein may further include operations, features, means, or instructions for receiving a report indicating a quantity of HARQ processes supported by the energy harvesting wireless device, where the quantity of HARQ processes indicates the first feedback process type.

In some examples of the method, apparatuses, and non-transitory computer-readable medium described herein, the report indicates a maximum quantity of HARQ processes.

Some examples of the method, apparatuses, and non-transitory computer-readable medium described herein may further include operations, features, means, or instructions for transmitting a retransmission of the message based on an expiration of an RTT timer.

Some examples of the method, apparatuses, and non-transitory computer-readable medium described herein may further include operations, features, means, or instructions for transmitting a low-power signal indicating a change to an RTT timer, a retransmission timer, or both.

Some examples of the method, apparatuses, and non-transitory computer-readable medium described herein may further include operations, features, means, or instructions for receiving a message indicating a set of multiple RTT timers, where an RTT timer of the set of multiple RTT timers may be based on the energy status information.

Some examples of the method, apparatuses, and non-transitory computer-readable medium described herein may further include operations, features, means, or instructions for starting an RTT timer based on transmitting the feedback information, where a duration of the RTT timer may be based on the energy status information.

Some examples of the method, apparatuses, and non-transitory computer-readable medium described herein may further include operations, features, means, or instructions for transmitting a retransmission of the message via a control channel during a duration of a retransmission timer and suspending the retransmission timer based on the energy harvesting wireless device entering an energy harvesting mode.

In some examples of the method, apparatuses, and non-transitory computer-readable medium described herein, transmitting the control signaling may include operations, features, means, or instructions for transmitting the control signaling indicating a quantity of HARQ processes based on the energy status information.

Some examples of the method, apparatuses, and non-transitory computer-readable medium described herein may further include operations, features, means, or instructions for transmitting a request to increase a quantity of HARQ processes based on the energy status information.

In some examples of the method, apparatuses, and non-transitory computer-readable medium described herein, the feedback information indicates one or more symbols of the message the energy harvesting wireless device failed to receive and the method, apparatuses, and non-transitory computer-readable medium may include further operations, features, means, or instructions for transmitting a second control message that indicates a HARQ process and the one or more symbols based on the feedback information.

In some examples of the method, apparatuses, and non-transitory computer-readable medium described herein, transmitting the second control message may include operations, features, means, or instructions for transmitting the second control message that indicates a bitmap, where the bitmap indicates the one or more symbols.

Some examples of the method, apparatuses, and non-transitory computer-readable medium described herein may further include operations, features, means, or instructions for rescheduling transmission of the one or more symbols that the energy harvesting wireless device failed to receive.

In some examples of the method, apparatuses, and non-transitory computer-readable medium described herein, receiving the energy status information may include operations, features, means, or instructions for receiving the energy status information indicating that the energy harvesting wireless device corresponds to a class of wireless devices that support energy harvesting.

In some examples of the method, apparatuses, and non-transitory computer-readable medium described herein, the energy status information includes an energy status profile, a charging rate profile, a discharging rate profile, a battery leakage rate profile, or a combination thereof.

### BRIEF DESCRIPTION OF THE DRAWINGS

FIG. 1 illustrates an example of a wireless communications system that supports feedback processes for energy harvesting devices in accordance with one or more aspects of the present disclosure.

FIG. 2 illustrates an example of a wireless communications system that supports feedback processes for energy harvesting devices in accordance with one or more aspects of the present disclosure.

FIG. 3 illustrates an example of a timing diagram that supports feedback processes for energy harvesting devices in accordance with one or more aspects of the present disclosure.

FIG. 4 illustrates an example of a data transmission diagram that supports feedback processes for energy harvesting devices in accordance with one or more aspects of the present disclosure.

FIG. 5 illustrates an example of a signaling diagram that supports feedback processes for energy harvesting devices in accordance with one or more aspects of the present disclosure.

FIG. 6 illustrates an example of a process flow that supports feedback processes for energy harvesting devices in accordance with one or more aspects of the present disclosure.

FIGS. 7 and 8 illustrate block diagrams of devices that support feedback processes for energy harvesting devices in accordance with one or more aspects of the present disclosure.

FIG. 9 illustrates a block diagram of a communications manager that supports feedback processes for energy harvesting devices in accordance with one or more aspects of the present disclosure.

FIG. 10 illustrates a diagram of a system including a device that supports feedback processes for energy harvesting devices in accordance with one or more aspects of the present disclosure.

FIGS. 11 and 12 illustrate block diagrams of devices that support feedback processes for energy harvesting devices in accordance with one or more aspects of the present disclosure.

FIG. 13 illustrates a block diagram of a communications manager that supports feedback processes for energy harvesting devices in accordance with one or more aspects of the present disclosure.

FIG. 14 illustrates a diagram of a system including a device that supports feedback processes for energy harvesting devices in accordance with one or more aspects of the present disclosure.

FIGS. 15 through 20 illustrate flowcharts showing methods that support feedback processes for energy harvesting devices in accordance with one or more aspects of the present disclosure.

### DETAILED DESCRIPTION

In some wireless communications systems, an energy harvesting device (e.g., a radio frequency identification (RFID) tag, a passive device, a very low power device, a passive IOT device, a zero power IOT device, or other energy harvesting wireless devices) may accumulate energy during some communication activities. To process a specific message (e.g., a data packet of a control channel, a reference signal, one or more data symbols), the energy harvesting device may accumulate and store at least the amount of energy that it may use for processing the message. Accordingly, the energy harvesting device and a transmitting device may benefit from having information regarding how much energy the energy harvesting device may use to process a given message, which may be based on a defined power model. However, in some examples, an amount of energy stored at the energy harvesting device may fall below the amount of energy that it uses for processing the message (e.g., as defined by the power model). For example, the energy harvesting device may lose energy due to battery leakage or discharging associated with other communication activities, which may result in at least some symbols of the message being dropped.

In some examples, the energy harvesting device may cycle between a wireless communication mode, during which the energy harvesting device may perform some wireless communications with a separate wireless device, and an energy harvesting mode, during which the energy harvesting device may accumulate energy. The energy harvesting device may cycle between these modes to maintain an amount of energy stored at the energy harvesting device in accordance with the defined power model. However, the energy harvesting device may switch to an energy harvesting mode during a retransmission of a message (e.g., data) or transmission of a feedback message associated with the message. In such cases, the energy harvesting device may fail to receive at least a portion of the retransmission or the feedback message, which may cause miscommunication between the energy harvesting device and the transmitting device or may impact reliability or accuracy of data communicated.

In accordance with examples described herein, the energy harvesting device may support changes to a feedback procedure (e.g., a hybrid automatic repeat request (HARQ) procedure) for transmission or reception of messages. For example, an energy harvesting device may transmit a message indicating energy status information (e.g., an energy status profile, a charging rate profile, a discharging rate profile, a battery leakage rate profile, and the like) of the energy harvesting device such that a transmitting device (e.g., a network node) may adapt the feedback procedure based on the energy status information. In some examples, the energy harvesting device and the transmitting device may use an automatic repeat request processes (ARQ) as opposed to HARQ processes. In some other examples, the energy harvesting device and the transmitting device may use a HARQ procedure, and the energy harvesting device may indicate a quantity of HARQ processes (e.g., a maximum quantity of HARQ processes) that the energy harvesting device may support based on the energy status information. In some cases, the energy harvesting device or the transmitting device may dynamically configure timers (e.g., a round trip time (RTT) timer, a retransmission timer) associated with the feedback procedure based on the energy status information.

By supporting changes to a feedback procedure, an energy harvesting device may support reduced power consumption at the energy harvesting device. For example, the energy harvesting device may limit a quantity of HARQ processes such that an amount of energy stored at the energy harvesting device maintains some quantity indicated by the defined power model. Accordingly, the energy harvesting device may reduce power consumed during HARQ processes that are performed incorrectly or in excess. Additionally, the energy harvesting device may reduce errors in communication of data messages by maintaining sufficient power to perform accurate processing of messages received. For example, the energy harvesting device may extend a timer associated with a feedback procedure until the energy harvesting device has stored sufficient power to perform processing of a message without error, which may improve reliability and efficiency of communications between the energy harvesting device and a transmitting device.

Aspects of the disclosure are initially described in the context of wireless communications systems. Aspects of the disclosure are additionally described with reference to timing diagrams, data transmission diagrams, signaling diagrams, and process flows. Aspects of the disclosure are further illustrated by and described with reference to apparatus diagrams, system diagrams, and flowcharts that relate to feedback processes for energy harvesting devices.

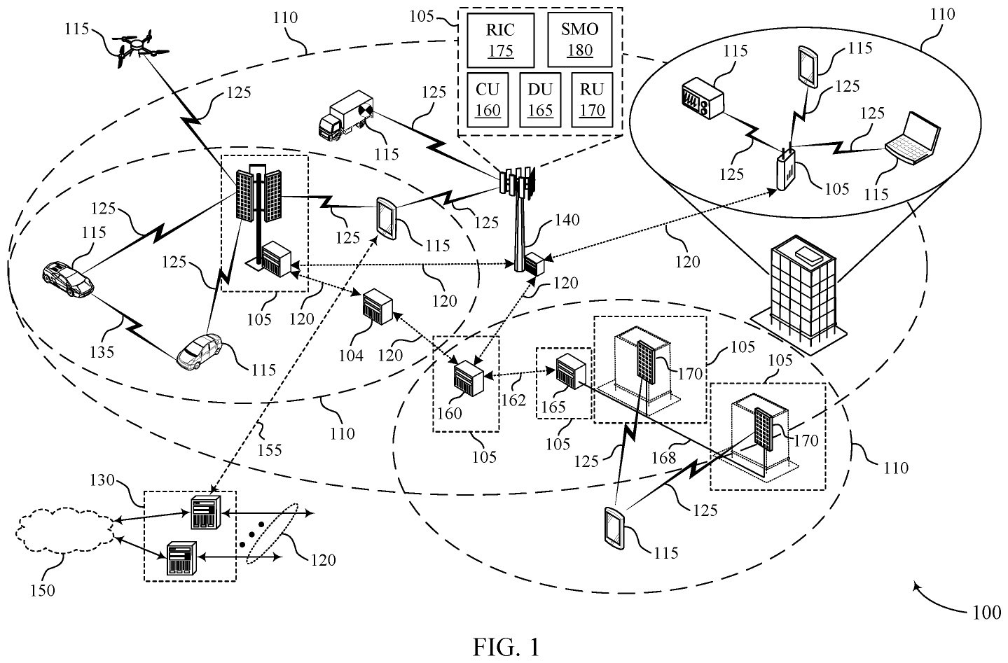

FIG. 1 illustrates an example of a wireless communications system 100 that supports feedback processes for energy harvesting devices in accordance with one or more aspects of the present disclosure. The wireless communications system 100 may include one or more network nodes 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network nodes 105 may be dispersed throughout a geographic area to form the wireless communications system 100 and may include devices in different forms or having different capabilities. In various examples, a network node 105 may be referred to as a network element, a mobility element, a radio access network (RAN) node, or network equipment, among other nomenclature. In some examples, network nodes 105 and UEs 115 may wirelessly communicate via one or more communication links 125 (e.g., a radio frequency (RF) access link). For example, a network node 105 may support a coverage area 110 (e.g., a geographic coverage area) over which the UEs 115 and the network node 105 may establish one or more communication links 125. The coverage area 110 may be an example of a geographic area over which a network node 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network nodes 105, as shown in FIG. 1.

As described herein, a node of the wireless communications system 100, which may be referred to as a network node, or a wireless node, may be a network node 105 (e.g., any network node described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network node 105. As another example, a first node may be configured to communicate with a second node or a third node. In one aspect of this example, the first node may be a UE 115, the second node may be a network node 105, and the third node may be a UE 115. In another aspect of this example, the first node may be a UE 115, the second node may be a network node 105, and the third node may be a network node 105. In yet other aspects of this example, the first, second, and third nodes may be different relative to these examples. Similarly, reference to a UE 115, network node 105, apparatus, device, computing system, or the like may include disclosure of the UE 115, network node 105, apparatus, device, computing system, or the like being a node. For example, disclosure that a UE 115 is configured to receive information from a network node 105 also discloses that a first node is configured to receive information from a second node.

In some examples, network nodes 105 may communicate with the core network 130, or with one another, or both. For example, network nodes 105 may communicate with the core network 130 via one or more backhaul communication links 120 (e.g., in accordance with an S1, N2, N3, or other interface protocol). In some examples, network nodes 105 may communicate with one another via a backhaul communication link 120 (e.g., in accordance with an X2, Xn, or other interface protocol) either directly (e.g., directly between network nodes 105) or indirectly (e.g., via a core network 130). In some examples, network nodes 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network nodes 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network node 105 (e.g., a base station 140) may be implemented in an aggregated (e.g., monolithic, standalone) base station architecture, which may be configured to utilize a protocol stack that is physically or logically integrated within a single network node 105 (e.g., a single RAN node, such as a base station 140).

In some examples, a network node 105 may be implemented in a disaggregated architecture (e.g., a disaggregated base station architecture, a disaggregated RAN architecture), which may be configured to utilize a protocol stack that is physically or logically distributed among two or more network nodes 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network node 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network nodes 105 in a disaggregated RAN architecture may be co-located, or one or more components of the network nodes 105 may be located in distributed locations (e.g., separate physical locations). In some examples, one or more network nodes 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network nodes 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network nodes 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network node 105 (e.g., a donor base station 140). The one or more donor network nodes 105 (e.g., IAB donors) may be in communication with one or more additional network nodes 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support feedback processes for energy harvesting devices as described herein. For example, some operations described as being performed by a UE 115 or a network node 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network nodes 105 and the network equipment including macro eNBs or gNBs, small cell eNBs or gNBs, or relay base stations, among other examples, as shown in FIG. 1.

The UEs 115 and the network nodes 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network node 105 and other devices may refer to communication between the devices and any portion (e.g., entity, sub-entity) of a network node 105. For example, the terms “transmitting,” “receiving,” or “communicating,” when referring to a network node 105, may refer to any portion of a network node 105 (e.g., a base station 140, a CU 160, a DU 165, a RU 170) of a RAN communicating with another device (e.g., directly or via one or more other network nodes 105).

The communication links 125 shown in the wireless communications system 100 may include downlink transmissions (e.g., forward link transmissions) from a network node 105 to a UE 115, uplink transmissions (e.g., return link transmissions) from a UE 115 to a network node 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network nodes 105, the UEs 115, or both) may have hardware configurations that support communications using a particular carrier bandwidth or may be configurable to support communications using one of a set of carrier bandwidths. In some examples, the wireless communications system 100 may include network nodes 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element (RE) may refer to resources of one symbol period (e.g., a duration of one modulation symbol) and one subcarrier, in which case the symbol period and subcarrier spacing may be inversely related. The quantity of bits carried by each RE may depend on the modulation scheme (e.g., the order of the modulation scheme, the coding rate of the modulation scheme, or both), such that a relatively higher quantity of REs (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network nodes 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network node 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network node 105. In some other examples, the overlapping coverage areas 110 associated with different technologies may be supported by different network nodes 105. The wireless communications system 100 may include, for example, a heterogeneous network in which different types of the network nodes 105 provide coverage for various coverage areas 110 using the same or different radio access technologies.

The wireless communications system 100 may support synchronous or asynchronous operation. For synchronous operation, network nodes 105 (e.g., base stations 140) may have similar frame timings, and transmissions from different network nodes 105 may be approximately aligned in time. For asynchronous operation, network nodes 105 may have different frame timings, and transmissions from different network nodes 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network node 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network node 105 (e.g., a base station 140, an RU 170), which may support aspects of such D2D communications being configured by (e.g., scheduled by) the network node 105. In some examples, one or more UEs 115 of such a group may be outside the coverage area 110 of a network node 105 or may be otherwise unable to or not configured to receive transmissions from a network node 105. In some examples, groups of the UEs 115 communicating via D2D communications may support a one-to-many (1:M) system in which each UE 115 transmits to each of the other UEs 115 in the group. In some examples, a network node 105 may facilitate the scheduling of resources for D2D communications. In some other examples, D2D communications may be carried out between the UEs 115 without an involvement of a network node 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network nodes 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network nodes 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network node 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network node 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network node 105 may be located at diverse geographic locations. A network node 105 may include an antenna array with a set of rows and columns of antenna ports that the network node 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network node 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network node 105 or a UE 115 may use beam sweeping techniques as part of beamforming operations. For example, a network node 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network node 105 multiple times along different directions. For example, the network node 105 may transmit a signal according to different beamforming weight sets associated with different directions of transmission. Transmissions along different beam directions may be used to identify (e.g., by a transmitting device, such as a network node 105, or by a receiving device, such as a UE 115) a beam direction for later transmission or reception by the network node 105.

Some signals, such as data signals associated with a particular receiving device, may be transmitted by transmitting device (e.g., a transmitting network node 105, a transmitting UE 115) along a single beam direction (e.g., a direction associated with the receiving device, such as a receiving network node 105 or a receiving UE 115). In some examples, the beam direction associated with transmissions along a single beam direction may be determined based on a signal that was transmitted along one or more beam directions. For example, a UE 115 may receive one or more of the signals transmitted by the network node 105 along different directions and may report to the network node 105 an indication of the signal that the UE 115 received with a highest signal quality or an otherwise acceptable signal quality.

In some examples, transmissions by a device (e.g., by a network node 105 or a UE 115) may be performed using multiple beam directions, and the device may use a combination of digital precoding or beamforming to generate a combined beam for transmission (e.g., from a network node 105 to a UE 115). The UE 115 may report feedback that indicates precoding weights for one or more beam directions, and the feedback may correspond to a configured set of beams across a system bandwidth or one or more sub-bands. The network node 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network node 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network node 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network node 105 or a core network 130 supporting radio bearers for user plane data. A PHY layer may map transport channels to physical channels.

The UEs 115 and the network nodes 105 may support retransmissions of data to increase the likelihood that data is received successfully. HARQ feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., ARQ). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In accordance with examples described herein, a UE 115 (e.g., an energy harvesting device) in the wireless communications system 100 may transmit energy status information for the UE 115. For instance, the UE 115 may cycle between an energy harvesting mode and a wireless communication mode. The UE 115 may receive, during the wireless communication mode, control signaling indicating to apply a first feedback process type of multiple different feedback process types based on the energy status information. In some examples, the UE 115 may receive a control message scheduling transmission of a message to the energy harvesting wireless device in a resource of a shared data channel. Accordingly, the UE 115 may monitor the resource for the message based on the control message and may transmit feedback information for the message in accordance with the indicated feedback process type.

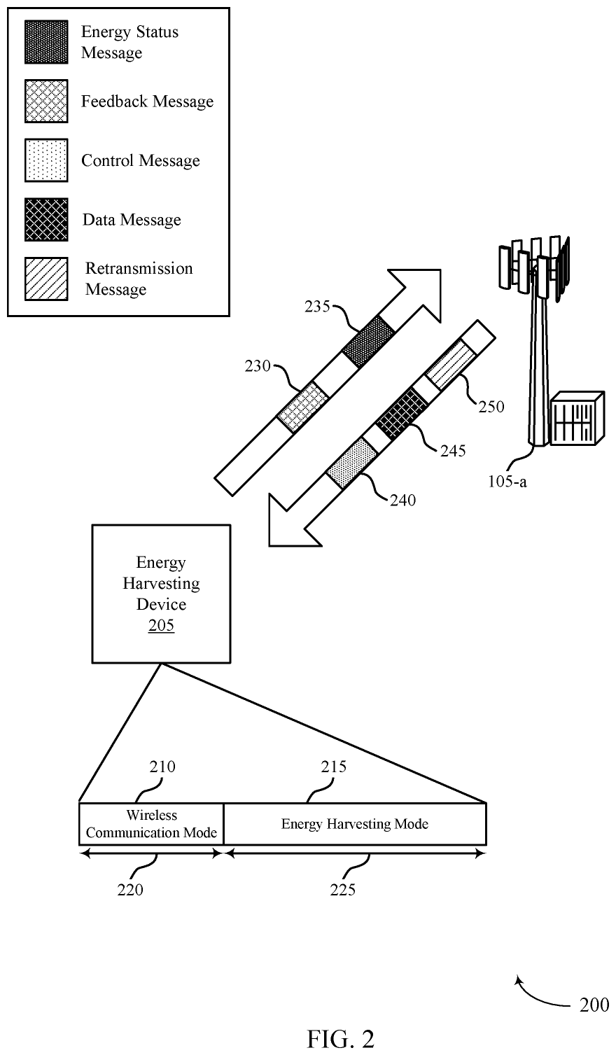

FIG. 2 illustrates an example of a wireless communications system 200 that supports feedback processes for energy harvesting devices in accordance with one or more aspects of the present disclosure. The wireless communications system 200 may implement or may be implemented by aspects of the wireless communications system 100. For example, the wireless communications system 200 may include an energy harvesting device 205, which may be an example of a UE 115 as described with reference to FIG. 1, and a network node 105-a, which may be an example of a network node 105 as described with reference to FIG. 1.

The energy harvesting device 205 (e.g., an RFID tag, a UE 115 or another energy harvesting wireless device) may cycle between a wireless communication mode 210 and an energy harvesting mode 215. While operating in the wireless communication mode 210, the energy harvesting device 205 may perform various wireless communications activities (e.g., transmitting messages, receiving messages, or other communications activities). While operating in the energy harvesting mode 215, the energy harvesting device 205 may accumulate (e.g., harvest) energy using one or more energy harvesting technologies (e.g., RF, solar, thermal, or other energy harvesting technologies).

In some examples, the energy harvesting device 205 or the network node 105-a may design a device activity cycle to determine an energy harvesting-to-activity time ratio for the energy harvesting device 205. That is, the energy harvesting device 205 may determine a duration 225 during which the energy harvesting device 205 may operate in an energy harvesting mode 215 and a duration 220 during which the energy harvesting device 205 may operate in a wireless communication mode 210. The energy harvesting device 205 or the network node 105-a may design the activity cycle based on an input power (e.g., Pₓ) to the energy harvesting device 205 and an activity power (e.g., P_{y}) that the energy harvesting device 205 may consume while performing a wireless communications activity. In some examples, the device activity cycle may be a discontinuous reception (DRX) cycle for energy harvesting devices.

While operating in the energy harvesting mode 215, the input power to the energy harvesting device 205 may be equal to Pₓ and an energy harvesting conversion efficiency (e.g., RF-to-DC conversion efficiency) at the input power Pₓ may be ηₓ. As such, the energy harvesting device 205 may harvest power equal to Pₓ×ηₓ. In some cases, the energy harvesting device may perform energy harvesting over a duration 225 equal to X time units. While operating in the wireless communication mode 210, the energy harvesting device 205 may perform a wireless communications activity and consume an activity power (e.g., integrated chip (IC) power) equal to P_{y}. The energy harvesting device 205 may perform the wireless communications activity over a duration 220 (e.g., a reading duration, an on duration) equal to Y time units. Accordingly, the energy harvesting device may be capable of performing the wireless communications activity when Pₓ×ηₓ×X is greater than P_{y}×Y. That is, the energy harvesting device 205 may be capable of performing the wireless communications activity when the energy harvesting device accumulates an amount of energy that is greater than an amount of energy the energy harvesting device 205 consumes performing the activity. As such, the energy harvesting device 205 may determine the duration 225 to exceed (P_{y}×Y)/(Pₓ×ηₓ) such that the energy harvesting device 205 may accumulate enough energy to perform the wireless communications activity. The energy harvesting device 205 may determine an energy harvesting-to-activity ratio X/Y to be P_{y}/Pₓ×ηₓ.

In some cases, the energy harvesting device 205 may use multiple energy harvesting techniques (e.g., RF, solar, thermal, and any other energy harvesting techniques) to accumulate energy during an energy harvesting mode 215. The energy harvesting device 205 may accumulate energy that is equal to the sum of the energy harvested from each of the various energy harvesting techniques. For example, the energy harvesting device 205 may use solar energy harvesting with a solar input power of Pₛ and a solar-to-DC conversion efficiency of ns. In such an example, the energy harvesting device may accumulate energy from harvesting equal to (Pₓηₓ+Pₛηₛ)×X, where X may be equal to the duration 225. In some cases, the energy harvesting device 205 may consume activity energy by performing multiple different wireless communications activities (e.g., transmitting a message, receiving a message). The energy harvesting device 205 may consume activity energy equal to the sum of the activity energy consumed for each of the various activities. For example, the energy harvesting device 205 may transmit a message with an IC power of P_{y} over an activity duration of Y time units and may receive a message with an IC power of P_{q} over an activity duration of Q time units. In such an example, the energy harvesting device may consume an activity energy equal to (P_{y}×Y)+(P_{q}×Q).

In a non-limiting example, the IC power P_{y} may be 10 μW. The input power to the energy harvesting device 205 may be −37 dBm, and an energy harvesting conversion efficiency ηₓ may be equal to 1%. Accordingly, the energy harvesting-to-activity ratio X/Y may be 5000. In such examples, if the activity duration Y (e.g., the duration 220) is 10 ms, the energy harvesting duration X (e.g., the duration 225) may be 50 s. In other examples, the IC power P_{y} may still be 10 μW, but the input power to the energy harvesting device 205 may increase to −20 dBm, and the energy harvesting conversion efficiency ηₓ may increase to 10%. Accordingly, the energy harvesting-to-activity ratio X/Y may be 10. In such examples, if the activity duration Y (e.g., the duration 220) is 10 ms, the energy harvesting duration X (e.g., the duration 225) may be 0.1 s. In some cases, such as during a high SINR regime, when X/Y is relatively small and when an input power to the energy harvesting device 205 is high, the energy harvesting device 205 may harvest energy during the wireless communication mode 210, which may provide some benefit to the energy harvesting device 205.

The energy harvesting device 205 may be, as an example, an internet of things (IOT) device operating at 180 KHz and with a 15 kHz subcarrier spacing (SCS) (e.g., a 1 ms slot duration), such that the energy harvesting device 205 may use 12 REs or 1 RB for wireless communications. On a per-RB basis, or for a normalized quantity of REs or RBs, the energy harvesting device 205 may determine that a power to process a demodulation reference signal (DMRS) signal may be P_{dmrs}, a power to process a low-density parity check (LDPC)-coded data signal may be P_{data}, a power to process a polar-coded information signal may be P_{control_polar} or may be simplified as P_{pdech} (e.g., power to process polar-coded DCI), and a power to process a sequence-based control may be P_{control_seq}. The energy harvesting device 205 may transmit signaling to indicate such power information, or the energy harvesting device 205 may indicate the power information over time. In some examples, the power P_{data} may represent a power to process a DMRS per modulation and coding scheme (MCS) quantity (e.g., a function of a coding rate, a modulation order, or both). In some cases, an impact of an MCS on P_{data} may be less significant than an impact of running an LDPC decoder on P_{data}.

The energy harvesting device 205 may indicate a detailed power model to the network node 105-a. For example, the energy harvesting device 205 may indicate amounts of power that the energy harvesting device 205 may consume to perform various wireless communications activities. The energy harvesting device 205 may indicate the amounts of power in the detailed power model on a per-RB or per-RE basis, or the energy harvesting device 205 may indicate the amounts of power for a particular time frequency block. The energy harvesting device 205 may indicate the detailed power model based on an association with a class of energy harvesting devices.

The detailed power model may indicate amounts of power for different reference signal types. For example, the detailed power model may indicate an amount of power for reference signal (RS) type 1 (e.g., DMRS) processing as P_{RS1}, which may be a function of a quantity of ports or may be indicated on a per-port basis. The detailed power model may indicate an amount of power for RS type 2 (e.g., synchronization signal block (SSB)) processing as P_{RS2} and an amount of power for RS type 3 (e.g., tracking reference signal (TRS), phase tracking reference signal (PTRS), or both) processing as P_{RS3}. The detailed power model may indicate an amount of power for RS type 4 (e.g., CSI-RS) processing as P_{RS4}, which, in some examples, may be a function of a quantity of CSI-RS ports if multi-port CSI-RS is supported for the energy harvesting device 205. In some examples, P_{RS4} may be normalized per port and may be computed based on a quantity of ports. Additionally, or alternatively, P_{RS4} may be a linear or non-linear function (e.g., piecewise linear, polynomial or other function).

In some examples, the detailed power model may indicate an amount of power for data processing (e.g., uplink, downlink, or both), which may be parametrized per MCS or per modulation order of an MCS. In some cases, the detailed power model may indicate an amount of power for physical downlink control channel (PDCCH) processing, which may be based on some format associated with a bit size. Additionally, or alternatively, the detailed power model may indicate an amount of power for physical uplink control channel (PUCCH) processing (e.g., encoding, preparation), which may be based on a format, a waveform, a DMRS structure, a data structure, an encoding procedure, or any combination thereof.

In some cases, the detailed power model may indicate a cost (e.g., an amount of power) for monitoring that is unrelated to signal processing (e.g., an amount of power for detecting no DCI based on DCI DMRS). The amount of power for monitoring may correspond to an amount of power for operating at least one of a clock, a hardware component, a firmware component, a software component, or an RF component. Additionally, or alternatively, the detailed power model may indicate an energy lost to battery leakage (e.g., d_{leakage}) in terms of dB per RB, dB per RE, or any other unit of energy (e.g., mJ, μJ, and the like). In some examples, the detailed power model may indicate a battery size. For uplink communications, the network node 105-a may determine a transmit power of the energy harvesting device 205 and may send one or more power control commands (e.g., a control message) to manage the transmit power of the energy harvesting device 205 based on the power model for the energy harvesting device 205.

The energy harvesting device 205 may transmit an energy status message 235 to the network node 105-a, which may indicate the detailed power model. The energy status message 235 may also indicate energy status information of the energy harvesting device 205 such as an energy status profile, a charging rate profile, a discharging rate profile, and a battery leakage profile, among other energy status profiles or other energy status information for the energy harvesting device 205. The profiles in the energy status message 235 may include past (e.g., previous) values, current values, predicted future values, or any combination thereof.

The network node 105-a may transmit a control message 240 to the energy harvesting device 205 that may include control signaling indicating to apply a feedback process type based on the energy status message 235. The feedback process type may include a HARQ process, an ARQ process, and the like. In addition, the control message 240 may schedule a transmission of a data message 245 to the energy harvesting device 205 in a resource of a shared data channel. The network node 105-a may transmit the data message 245 to the energy harvesting device 205, and in some cases, the energy harvesting device 205 may transmit a feedback message 230 to the network node 105-a based on the feedback process type. For example, based on the feedback process type, the energy harvesting device 205 may make enhancements to a HARQ procedure (e.g., dynamic RTT timer configuration, dynamic retransmission timer, quantity of HARQ processes). Alternatively, the energy harvesting device 205 may disable HARQ (e.g., use an ARQ procedure) based on the detailed power model, the feedback process type, or both. In some examples, the network node 105-a may transmit a retransmission 250 of the data message 245 based on the detailed power model, the feedback process type, or both.

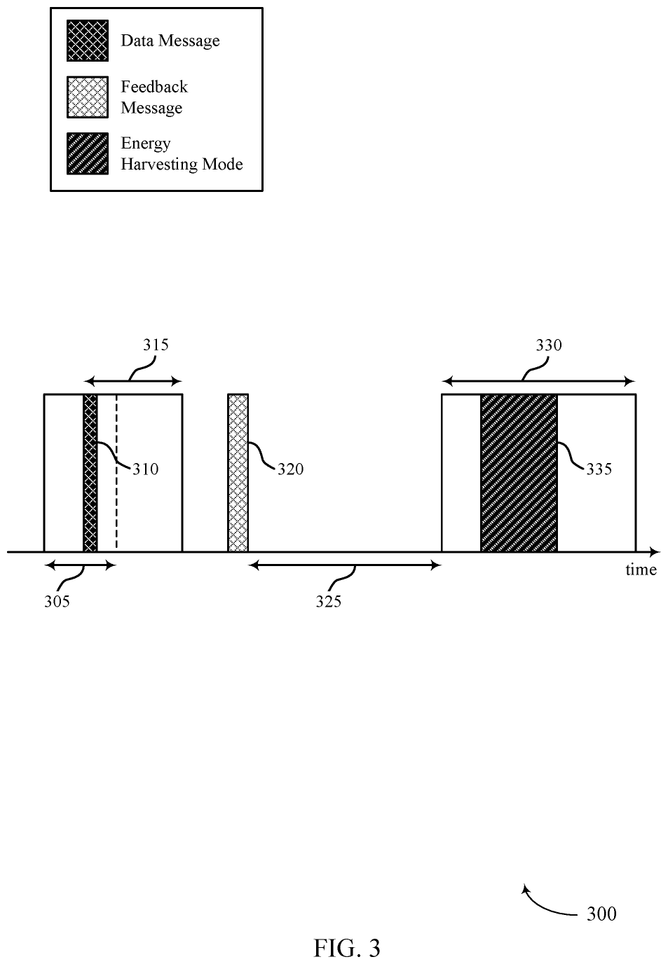

FIG. 3 illustrates an example of a timing diagram 300 that supports feedback processes for energy harvesting devices in accordance with one or more aspects of the present disclosure. The timing diagram 300 may implement or may be implemented by aspects of the wireless communications system 100 or the wireless communications system 200. For example, the timing diagram 300 may illustrate the timing of transmission of a data message 310, which may be an example of a data message 245 as described with reference to FIG. 2, transmission of a feedback message 320, which may be an example of a feedback message 230 as described with reference to FIG. 2, and a duration of an energy harvesting mode 335, which may be an example of an energy harvesting mode 215 as described with reference to FIG. 2.

An energy harvesting device (e.g., an RFID tag, a UE 115) may operate in an active state (e.g., DRX on) during a duration 305 (e.g., a duration of time). In some cases, the duration 305 may be indicated by a timer (e.g., DRX-onDurationTimer). While in the active state, the energy harvesting device may monitor a control channel (e.g., PDCCH) for a data message 310 (e.g., a physical downlink shared channel (PDSCH)). In some examples, in a connected mode DRX (CDRX), the energy harvesting device may initiate an inactivity timer with a duration 315 based on receiving the data message 310. Based on expiration of the inactivity timer, the energy harvesting device may enter an inactive state (e.g., DRX off). In the inactive state, the energy harvesting device may stop (e.g., suspend) monitoring of the control channel.

In some cases, the energy harvesting device may transmit a feedback message 320 which may indicate feedback associated with the data message 310 (e.g., ACK, NACK, or other feedback information). For example, the energy harvesting device may transmit a NACK message to indicate that the energy harvesting device incorrectly received the data message 310 (e.g., due to a CRC error, missing symbols, or other errors in the data message 310) and that the energy harvesting device requests a retransmission of the data message 310. Alternatively, the energy harvesting device may transmit an ACK message to indicate that the energy harvesting device correctly received the data message 310.

The energy harvesting device may initiate an RTT timer with a duration 325 based on transmitting the feedback message 320. The RTT timer or the duration 325 may be based on a HARQ processing time at a transmitting device (e.g., a network node, a base station). Based on expiration of the RTT timer, the energy harvesting device may re-enter an active state (e.g., DRX on) to receive a retransmission of the data message 310. The energy harvesting device may remain in the active state for a duration 330 of a retransmission timer. However, in some cases, an energy harvesting mode 335 of the energy harvesting device may overlap with the duration 330 of the retransmission timer. That is, the energy harvesting device may enter the energy harvesting mode 335 while the retransmission timer is running. In such cases, the energy harvesting device may be operating in an energy harvesting mode 335 during the retransmission of the data message 310, and as such, may fail to receive the retransmission.

In some examples, the duration 325 of the RTT timer may be fixed, which may prevent the energy harvesting device from entering an ultra-low power sleep mode. For example, the energy harvesting devices may perform regular sleep or may refrain from entering any sleep mode until a current transmission is finished. Accordingly, the energy harvesting device may stay awake until a transmission is finished. Additionally, a supercap leakage or a battery leakage may vary based on which sleeping mode the device is in. For example, the supercap leakage or the battery leakage may be increased when the device is on. For uplink transmissions, in cases where the duration 325 is fixed, the energy harvesting device may perform DMRS bundling and may operate a power amplifier to maintain a same phase coherency, which may consume excess power.

In accordance with examples described herein, the energy harvesting device may modify a HARQ procedure (e.g., a feedback transmission in accordance with a feedback process type) to support accurately receiving retransmissions of data messages and reducing power consumption at the energy harvesting device, among other benefits. In some examples, the energy harvesting device may associate with a class of wireless devices that supports energy harvesting. The energy harvesting device may request or perform ARQ processes in place of HARQ processes. In this way, any energy harvesting devices associated with the class of energy harvesting devices may refrain from requesting or performing HARQ processes. The energy harvesting device may transmit energy status information to a network node (e.g., a base station), the energy status information indicating that the energy harvesting device corresponds to the class of wireless devices that support energy harvesting (e.g., the class of energy harvesting devices). In addition, the network node may schedule transmissions (e.g., downlink transmissions, uplink transmissions, sidelink transmissions) to the energy harvesting device in accordance with an ARQ procedure based on the energy status information indicating the class.

In some cases, the energy harvesting device may dynamically determine to request or perform ARQ processes instead of HARQ processes based on energy status information (e.g., energy status profile, charging rate profile, discharging rate profile, battery leakage rate profile, or a combination thereof), which may reduce memory usage, energy, or processing of the energy harvesting device. In some examples, the energy harvesting device may indicate its preference to perform an ARQ process instead of a HARQ process to the network node. For example, the energy harvesting device may transmit updated energy status information to the network node. The energy harvesting device may receive control signaling indicating to change from applying a first feedback process type (e.g., a HARQ process) to a second feedback process type (e.g., an ARQ process) based on the updated energy status information. That is, the network node may schedule transmissions to the energy harvesting device in accordance with an ARQ procedure based on the updated energy status information.

In other examples, the energy harvesting device may indicate to the network node that the energy harvesting device supports a maximum quantity of HARQ processes, which may be zero. The energy harvesting device may indicate the quantity (in some cases, a maximum quantity) of supported HARQ process in a report, where the quantity of supported HARQ processes may indicate the first feedback process type. In some cases, a maximum quantity of supported HARQ processes being zero may indicate the second feedback process type (e.g., an ARQ process).

In some examples, the energy harvesting device may dynamically modify the RTT timer (e.g., the duration 325) or the retransmission timer (e.g., the duration 330) to transmit or receive retransmissions of data messages (e.g., uplink messages, downlink messages, sidelink messages). For example, the energy harvesting device may shorten the RTT timer in an uplink communication, a downlink communication, or a sidelink communication, which may allow the energy harvesting device to flush memory more quickly and may save energy at the energy harvesting device. In some examples, the energy harvesting device may transmit a handshake request to the network node to determine if the network node supports dynamically modifying the RTT timer or the retransmission timer.

In some examples, the energy harvesting device may dynamically modify the RTT timer or the retransmission timer based on energy status information (e.g., energy status profile, charging rate profile, discharging rate profile, battery leakage rate profile) for the energy harvesting device. For example, the energy harvesting device may shorten the RTT timer, which may enable the network node to transmit to the energy harvesting device before a battery of the energy harvesting device dies or a battery level of the energy harvesting device drops below a threshold. In some cases, the energy harvesting device may transmit a message indicating a set of RTT timers each based on the energy status information. Additionally, or alternatively, the network node may dynamically modify the RTT timer or the retransmission timer (e.g., based on the energy status information of the energy harvesting device) and may indicate the modified RTT timer or the modified retransmission timer to the energy harvesting device.

In some examples, the energy harvesting device may report (e.g., periodically report) the energy status information to a network node. In some cases, the network node may infer the duration 325 of the RTT timer based on a most recent report of the energy status information. In other cases, the energy harvesting device may indicate the duration 325 of the RTT timer in the report of the energy status information (e.g., based on tables indicated via RRC signaling or a MAC control element (MAC-CE)). The network node may indicate the duration 325 in a scheduling DCI (e.g., scheduling the data message 310), a non-scheduling DCI, a MAC-CE, or an RRC message.

In some examples, the network node may autonomously transmit a retransmission of the data message 310 based on the duration 325 (e.g., after the duration 325), where the energy harvesting device may autonomously monitor a control channel (e.g., a downlink channel, a sidelink channel) for receiving the retransmission of the data message 310 during the duration 325. In other examples, the energy harvesting device may autonomously wake up to monitor the control channel for the retransmission of the data message 310 based on expiration of an indicated RTT timer. Additionally, or alternatively, the energy harvesting device may autonomously transmit a retransmission of the data message 310 in an uplink transmission, where the network node may autonomously monitor an uplink control channel for receiving the retransmission during the duration 325. The energy harvesting device may enter an energy harvesting mode 335 and be unable to monitor the control channel, receive signals, transmit a retransmission, or a combination thereof, while performing energy harvesting (e.g., due to hardware limitations, software limitations, firmware limitations, RF limitations, or other device limitations).

In some examples, the energy harvesting device may identify that the energy harvesting mode 335 overlaps with the retransmission timer, or that an energy level at the energy harvesting device has dropped below a threshold during the retransmission timer, and may suspend (e.g., freeze, stop) the retransmission timer. Suspending the retransmission timer may allow more time for the network node to transmit a control message for retransmission of the data message 310. For example, the network node may wait to transmit the control message until the energy harvesting device has indicated to restart the retransmission timer or until the energy harvesting device has re-entered a wireless communication mode (e.g., from the energy harvesting mode 335). In this way, the energy harvesting device may perform energy harvesting during the duration 325 of the retransmission timer and based on entering the energy harvesting mode 335, and the energy harvesting device may suspend the retransmission timer based on entering the energy harvesting mode 335. Additionally, or alternatively, the network node may suspend or restart the retransmission timer associated with an uplink retransmission, downlink retransmission, or a sidelink retransmission based on receiving energy status information from the energy harvesting device.

In some examples, due to a reduced capability (e.g., limited storage, processing capability) of the energy harvesting device, the energy harvesting device may allocate memory for a threshold quantity of HARQ processes (e.g., 1 or 2 HARQ processes). The energy harvesting device may use overbooking for any HARQ processes that exceed the threshold quantity to support a total quantity of HARQ processes that is greater than the threshold quantity (e.g., 16 HARQ processes). Accordingly, the energy harvesting device may dynamically modify a quantity of HARQ processes or may indicate a maximum quantity of HARQ processes which may prevent overbooking of memory and support efficient memory allocation.

In some examples, the energy harvesting device may dynamically modify a quantity of HARQ (e.g., ACK/NACK) processes for uplink transmissions, downlink transmissions, sidelink transmissions, or a combination thereof, based on the energy status information (e.g., at least one of status profile, charging rate profile, discharging rate profile, battery leakage rate profile). The energy harvesting device may indicate a maximum quantity of HARQ processes for downlink and uplink transmissions or may indicate a maximum quantity of HARQ processes for a single transmission direction (e.g., uplink, downlink). In some cases, the energy harvesting device may transmit L1, L2, or L3 signaling to the network node indicating a quantity of HARQ processes that the energy harvesting device supports, and the network node may configure the quantity of HARQ processes based on the signaling. The L1, L2, or L3 signaling may be separate from other L1, L2, or L3 signaling or may be multiplexed (e.g., piggy backed) with other L1, L2, or L3 signaling (e.g., buffer status report, scheduling request, wakeup response signal, CSI, HARQ-ACK, power headroom report, among other forms of signaling). Additionally, or alternatively, the network node may dynamically modify a quantity of HARQ processes (e.g., a maximum quantity) for uplink, downlink, or sidelink transmissions at the energy harvesting device based on receiving the energy status information from the energy harvesting device.

In some examples, the network node may dynamically configure a quantity of HARQ processes for transmission of a data message 310 (e.g., uplink message, downlink message) based on a most recent report of the energy status information at the energy harvesting device. The network node may reconfigure the quantity of HARQ processes for transmission of the data message 310 based on receiving a report of updated energy status information from the energy harvesting device. In some examples, the network node may request to add one or more HARQ processes for transmission of the data message 310. The network node may add the one or more HARQ processes after receiving permission (e.g., admission, a positive ACK, a response to the request) from the energy harvesting device to add the one or more HARQ processes, which may be beneficial for energy harvesting devices with limited storage or processing capability, or for energy harvesting devices that use common buffers or other common resources for uplink and downlink. In some examples, the network node may transmit an indication to the energy harvesting device to check if the energy harvesting device has, or is storing, a circular buffer of an indicated uplink or downlink packet or an indicated HARQ process or HARQ ID.

In some examples, the energy harvesting device and the network node may indicate, via control signaling, respective capabilities to support the techniques described herein. For example, the energy harvesting device and the network node may support respective capabilities to change, adopt, or modify the RTT timer, the retransmission timer, or both. In some examples, the energy harvesting device and the network node may support dynamic indications of the changes, adaptations, or modifications to the timers (e.g., via a DCI message). In some cases, the energy harvesting device and the network node may be capable of supporting low-power signals that may change, adopt, or modify the RTT timer, the retransmission timer, or both. Additionally, or alternatively, the energy harvesting device and the network node may be capable of supporting partial retransmissions for uplink transmissions, downlink transmissions, sidelink communications, or any combination thereof.

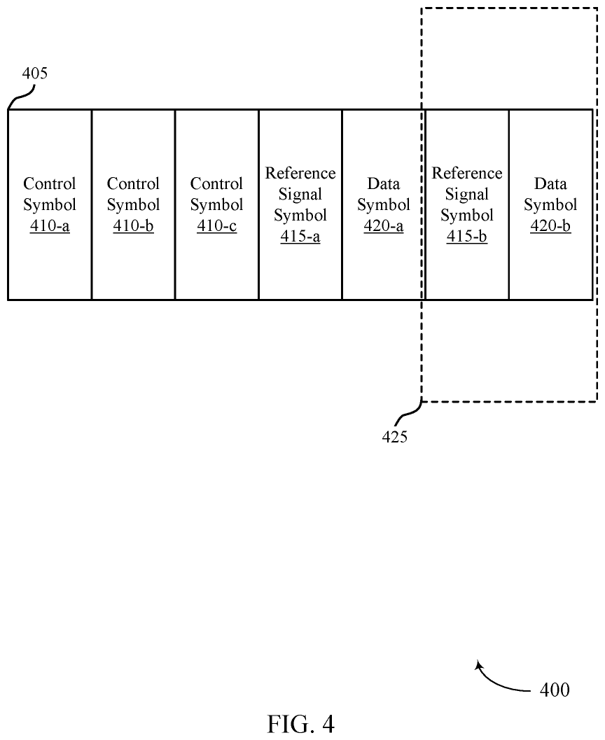

FIG. 4 illustrates an example of a data transmission diagram 400 that supports feedback processes for energy harvesting devices in accordance with one or more aspects of the present disclosure. The data transmission diagram 400 may implement or may be implemented by aspects of the wireless communications systems 100 and 200. For example, the data transmission diagram 400 may illustrate transmission of a data packet 405, which may be an example of a data message 245 as described with reference to FIG. 2 or a data message 310 as described with reference to FIG. 3.

The data packet 405 may include a quantity of X control symbols 410 (e.g., PDCCH symbols), a quantity of Y reference signal symbols 415 (e.g., DMRS symbols), and a quantity of Z data symbols 420, and the bandwidth may be a single resource block (e.g., BW=1 RB). For example, the data packet 405 may include three control symbols 410-a, 410-b, and 410-c; two reference signal symbols 415-a and 415-b; and two data symbols 420-a and 420-b. A power to process a control symbol 410 may be P_{control}, a power to process a reference signal symbol 415 may be P_{RS}, and a power to process a data symbol 420 may be P_{data}. Accordingly, an average power to process the data packet 405 may be P_{one_packet}=X×P_{control}+Y×P_{RS}+Z×P_{data}.

In some examples, an amount of energy stored at an energy harvesting device (e.g., an RFID tag, a low-power UE) may be P_{one_packet}×T_DL×beta, where beta may represent a scaling factor greater than one and may indicate a quantity of energy units of size P_{one_packet}. A network node may configure and indicate the quantities X, Y, and Z to the energy harvesting device, and the energy harvesting device may determine how much energy it may consume to process one data packet 405. The energy harvesting device may indicate a battery size or other energy status information to the network node, and the network node may determine beta based on the battery size or other energy status information. For a given bandwidth, the network node may configure the quantities of X, Y, and Z such that beta is at least 1.

In some examples, a battery leakage rate (e.g., leakage due to imperfection in battery, due to adding) may be d_{leakage} dB per OFDM symbol duration. A discharging rate may be d_{discharge} dB per OFDM symbol. Alternatively, the battery leakage rate or the discharging rate may be normalized per resource block. The discharging rate may be associated with monitoring wakeup signals, monitoring DCI signals, or performing or processing any other tasks (e.g., accessing memory, retrieving in-phase/quadrature-phase (I/Q) samples, clock power consumption, among other tasks). In total, an average power loss per OFDM symbol duration, or per resource block, may be d_{leakage}+d_{discharge} dB. In cases where beta is 1 and battery leakage or discharging is notable, some symbols of the data packet 405 may be lost.

In some cases, the energy harvesting device may receive the control symbols 410 (e.g., DCI), but the energy harvesting device may lack sufficient energy to process or receive one or more symbols of the data packet 405 or may otherwise be missing one or more symbols from the data packet 405. As such, the energy harvesting device may transmit a NACK to the network node. In some examples, the energy harvesting device may determine that each of the one or more missing symbols are reference signal symbols 415. In such examples, the energy harvesting device may not report or indicate the missing symbols to the network node and may receive a retransmission (e.g., a redundancy version, a full retransmission) of the data packet 405 from the network node.

In other examples, the energy harvesting device may determine that at least one of the one or more missing symbols is a data symbol 420. For example, the energy harvesting device may lack sufficient memory to store data symbols 420 until expiration of a HARQ RTT timer and may drop symbols proportionally over time until the network node retransmits the data packet 405. The energy harvesting device may indicate which symbols were missed via a HARQ feedback message (e.g., ACK/NACK message). For example, the energy harvesting device may indicate that the last L symbols out of Z total symbols were missing from the data packet 405, may indicate a bitmap indicating the missing symbols, or may transmit a start and length indicator value (SLIV) signal or similar signaling.

The network node may transmit a retransmission that includes the indicated missing symbols. Accordingly, the energy harvesting device may prevent the network node from retransmitting the entire data packet 405, which may save power at the network node, at the energy harvesting device, or both. In some cases, the energy harvesting device may indicate to the network node to transmit a full retransmission that includes an indicated redundancy version. The energy harvesting device may receive the retransmission of the data packet 405 in a downlink transmission in response to a NACK. In some cases, where the energy harvesting device is performing sidelink transmissions with another UE, the energy harvesting device may receive the retransmission including missing symbols or missing bundles of symbols indicated by the energy harvesting device in a sidelink transmission. Alternatively, the energy harvesting device may retransmit the data packet 405 in an uplink transmission in response to the network node requesting the retransmission of the data packet 405. For example, the network node may indicate in a request to the energy harvesting device which symbols or packets of symbols are missing, and the energy harvesting device may transmit a retransmission of the data packet 405 including the missing symbols or packet of symbols.

In some examples, the network node may modify a control message (e.g., a DCI, control symbols 410) for a retransmission of a data packet 405. The control message may indicate a HARQ ID (e.g., HARQ process ID) and one or more symbols that may be included in the retransmission based on an indication of missing symbols from the energy harvesting device. In some cases, the energy harvesting device may indicate a bundle 425 of symbols that are missing at the energy harvesting device or that the energy harvesting device failed to receive, which may, for example, include the reference signal symbol 415-b and the data symbol 420-b. An indication of which symbols to include in the bundle 425, or a quantity of symbols per bundle 425, or both, may be preconfigured at the energy harvesting device or may be based on a prior agreement between the energy harvesting device and the network node. The energy harvesting device may indicate one or more bundles 425 of symbols to the network node for retransmission, and the network node may transmit a retransmission that includes the one or more bundles 425.

In some cases, the network node may use repetition on a symbol-level transmission. Accordingly, the energy harvesting device may obtain any set of OFDM symbols. For example, the network node may repeat the one or more missing symbols within the retransmission of the missing symbols or may transmit the retransmission of the missing symbols repeatedly over multiple transmissions. A repetition pattern, a repetition factor, or both may be indicated in a RRC message, a MAC-CE message, or a DCI message. Additionally, or alternatively, the network node may use repetition on a bundle-level transmission.

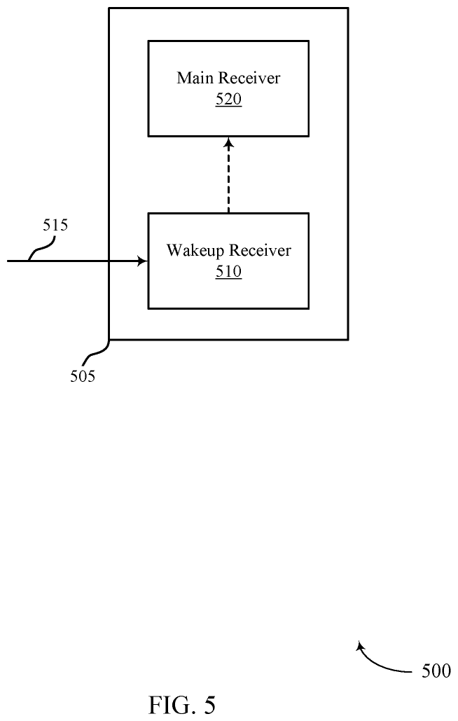

FIG. 5 illustrates an example of a signaling diagram 500 that supports feedback processes for energy harvesting devices in accordance with one or more aspects of the present disclosure. The signaling diagram 500 may implement or may be implemented by aspects of the wireless communications systems 100 and 200. For example, the signaling diagram 500 may include an energy harvesting device 505, which may be an example of a UE 115 as described with reference to FIG. 1 or may be an example of an energy harvesting device 205 as described with reference to FIG. 2.

The energy harvesting device 505 may include a wakeup receiver 510 (e.g., wakeup radio) and a main receiver 520. The main receiver 520 may be in a connected mode (e.g., on, active state) or the main receiver 520 may be in an idle mode (e.g., off, inactive state, sleep mode). In some examples, the energy harvesting device 505 may monitor the wakeup receiver 510 for receiving a message (e.g., configuration message, control message, data message, or any other message) regardless of which mode the main receiver 520 is in or regardless of which type of sleep the main receiver 520 is performing. Based on detecting or receiving a message, the wakeup receiver 510 may forward the message to the main receiver 520 or may trigger the main receiver to wake up (e.g., enter an active state). For example, the main receiver 520 may be in an inactive state where the main receiver has suspended monitoring of a channel (e.g., a PDCCH) for control signals, and the energy harvesting device 505 may use the wakeup receiver 510 for monitoring of control signals or other signals.

In some examples, a transmitting device (e.g., network node, gNB, sidelink UE, controlling UE in sidelink) may transmit a low power (LP) signal 515 to the wakeup receiver 510. For example, the low power signal 515 may indicate a modified retransmission timer or a modified RTT timer to the energy harvesting device 505 in accordance with examples described herein. That is the low power signal 515 may indicate a change to the RTT timer, the retransmission timer, or both. In some examples, the transmitting device may transmit capability signaling indicating a capability to support the change to the RTT timer, the retransmission timer, or both. The low power signal 515 may be one of an LP wakeup signal, an LP reference signal, an LP sync signal, or any other LP signal that carries control or data signals.

In some examples, the energy harvesting device 505 may support an interface (e.g., link) for communications with other devices (e.g., a transmitting device, a network node). The new interface may include a communication system where a first device (e.g., the transmitting device) transmits a waveform and the energy harvesting device 505 reflects or backscatters the waveform. The waveform may be a sinewave (e.g., single tone) or multi-tone (e.g., OFDM-based) waveform (e.g., RF waveform). The first device may refer to a network node, an IAB relay, a relay node, a RAN node, a gNB, a TRP associated with the NW, a sidelink UE (e.g., remote, primary, PLC, or a controlling unit in sidelink), a Uu link UE, or any other device. The waveform generated by the first device may carry data signals (e.g., PDSCH, PDSCH, PSSCH, among other examples), reference signals (e.g., CSI-RS, SRS, SSB, among other examples), random data, or reference signal symbols across different sub-channels or resource elements. In some examples, the waveform may be a sub-channel-modulated OFDM signal or waveform or a time-domain modulated OFDM-based signal or waveform.

In some examples, based on a capability of the energy harvesting device 505, the energy harvesting device 505 may generate a modulated waveform or signal. The modulated waveform may be one of a sinewave (e.g., a single tone wave) or a multi-tone wave (e.g., OFDM-based waveform). In some examples, the modulation may include on-off keying (OOK), amplitude-shift keying (ASK), frequency-shift keying (FSK), phase-shift keying (PSK), Zadoff Chu, DFT, Walshi/Hadamard, Gold, Reed-Solomon, m-sequence, or Chirp, among other modulation examples. In some examples, the modulation may occur in a time domain, in a frequency domain, or both. In some examples, Manchester coding may be used with ASK or OOK. In some examples, forward error correction codes and other channel coding may be applied, which may increase reliability.

In some aspects, an energy harvesting device 505 (e.g., a UE) may use two different interfaces. A first interface may be associated with a high-power mode (e.g., a lack of a low power saving mode) that may be associated with, or similar to, a Uu interface, a PC5 interface, and the like. A second interface may be associated with a same radio as the first interface. However, the second interface may be associated with deactivation of one or more of RF, hardware, software, or firmware components. In some examples, the second interface may be associated with a separate radio (e.g., a backscatter-based radio) to a tag (e.g., passive or semi-passive) to be used with low to very low power saving modes. Accordingly, the energy harvesting device 505 may maximize power savings.

In some cases, there may be an association between an interface used and a type of signal. That is, the energy harvesting device 505 may select an interface based on the type of signal transmitted or received. For example, if the signal is lower priority than data signals, regular signals, or legacy uplink signals (e.g., HARQ-ACK, CSI report), the energy harvesting device 505 may use the second interface. If the signal is high priority (e.g., data signal), the energy harvesting device 505 may use the first interface. In some cases, a network node may assign different signals to different interfaces based on priority, quality of service (QOS) requirements, power saving at the network node, power saving at the energy harvesting device 505 (e.g., UE), reported energy status information at the energy harvesting device 505 (e.g., energy charging rate profile, discharging/power consumption rate profile, energy state/level profile), preferences of the energy harvesting device 505, traffic, or any combination thereof. In some examples, the energy harvesting device 505 may request an indicated mapping between signals and interfaces using L1, L2, or L3 (e.g., dedicated L1, L2, or L3 signaling or L1, L2, or L3 signaling piggy backed or multiplexed with other signals) and the network node may configure the mapping using L1, L2, or L3 (e.g., UE assistance information (UAI)) signaling.

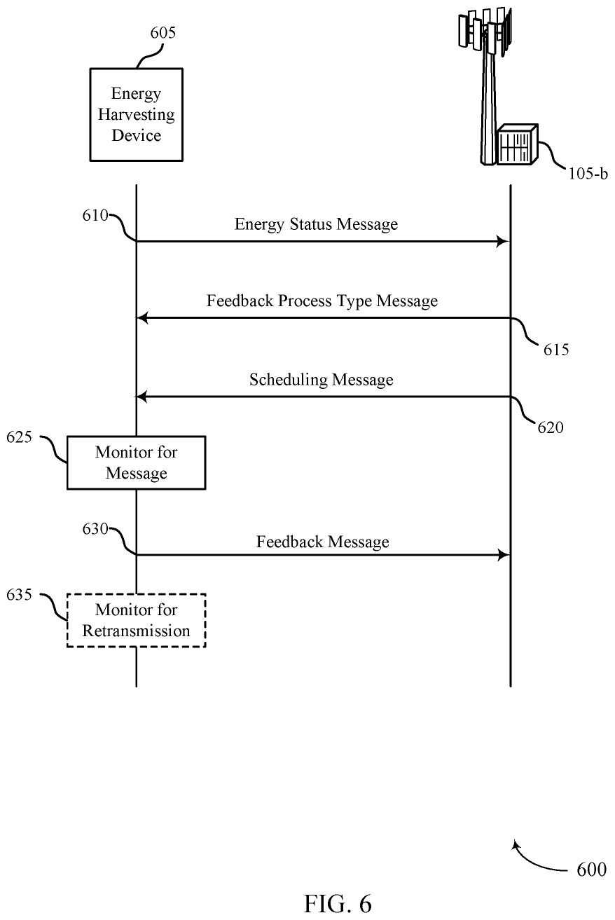

FIG. 6 illustrates an example of a process flow 600 that supports feedback processes for energy harvesting devices in accordance with one or more aspects of the present disclosure. The process flow 600 may implement or may be implemented by aspects of the wireless communications systems 100 and 200. For example, the process flow 600 may illustrate operations between an energy harvesting device 605 and a network node 105-b, which may be examples of corresponding devices described herein. In the following description of the process flow 600, the operations between the energy harvesting device 605 and the network node 105-b may be transmitted in a different order than the example order shown, or the operations performed by the energy harvesting device 605 and the network node 105-b may be performed in different orders or at different times. Some operations may also be omitted from the process flow 600, and other operations may be added to the process flow 600.

At 610, the energy harvesting device 605 may transmit, to the network node 105-b, energy status information for the energy harvesting device 605, where the energy harvesting device 605 may cycle between an energy harvesting mode and a wireless communication mode. In some examples, the energy status information may indicate that the energy harvesting device corresponds to (e.g., is associated with, belongs to) a class of wireless devices that support energy harvesting. In some cases, the energy status information may include an energy status profile, a charging rate profile, a discharging rate profile, a battery leakage rate profile, or a combination thereof.

At 615, the energy harvesting device 605 may receive, from the network node 105-b and during the wireless communication mode, control signaling indicating to apply a first feedback process type of multiple different feedback process types based on the energy status information. The first feedback process type may include a HARQ process. In some examples, the network node 105-b may receive updated energy status information from the energy harvesting device 605, in which case the control signaling may indicate to change from applying the first feedback process type to a second feedback process type based on the updated energy status information. The second feedback process type may include an ARQ process (e.g., instead of a HARQ process). Additionally, or alternatively, the control signaling may dynamically modify an RTT timer or a retransmission timer associated with a retransmission of a message. In some examples, the control signaling may be an LP signal (e.g., LP wakeup signal, LP reference signal, LP sync signal), and the energy harvesting device may receive the control signaling at a wakeup receiver of the energy harvesting device 605.

At 620, the energy harvesting device 605 may receive, from the network node 105-b, a control message (e.g., PDCCH) scheduling transmission of the message (e.g., a data message) to the energy harvesting device 605 in a resource of a shared data channel (e.g., PDSCH). At 625, the energy harvesting device 605 may monitor the resource for the message based on the control message.

At 630, the energy harvesting device 605 may transmit to the network node 105-b, feedback information (e.g., ACK, NACK) for the message in accordance with the indicated first feedback process type. For example, the feedback information may indicate one or more symbols (e.g., missing symbols, missing bundles of symbols) of the message the energy harvesting device 605 failed to receive. In some examples, the energy harvesting device 605 may start (e.g., initiate) an RTT timer based on transmitting the feedback information. A duration of the RTT timer may be based on the energy status information. For example, the energy harvesting device 605 may transmit a message to the network node 105-b indicating multiple RTT timers where at least one of the RTT timers is based on the energy status information. The network node 105-b may infer an RTT timer based on the energy status information of the energy harvesting device 605.

At 635, the energy harvesting device may monitor for a retransmission of the message based on an expiration of the RTT timer and during a duration of the retransmission timer. In some examples, the energy harvesting device 605 may enter an energy harvesting mode (e.g., to perform energy harvesting) during the duration of the retransmission timer and may suspend (e.g., freeze, stop) the retransmission timer based on entering the energy harvesting mode. In some examples, the retransmission may be a full retransmission (e.g., a redundancy version) of the message. In other examples, the retransmission may include one or more symbols (e.g., missing symbols, missing bundles of symbols) the energy harvesting device 605 failed to receive based on the feedback information.

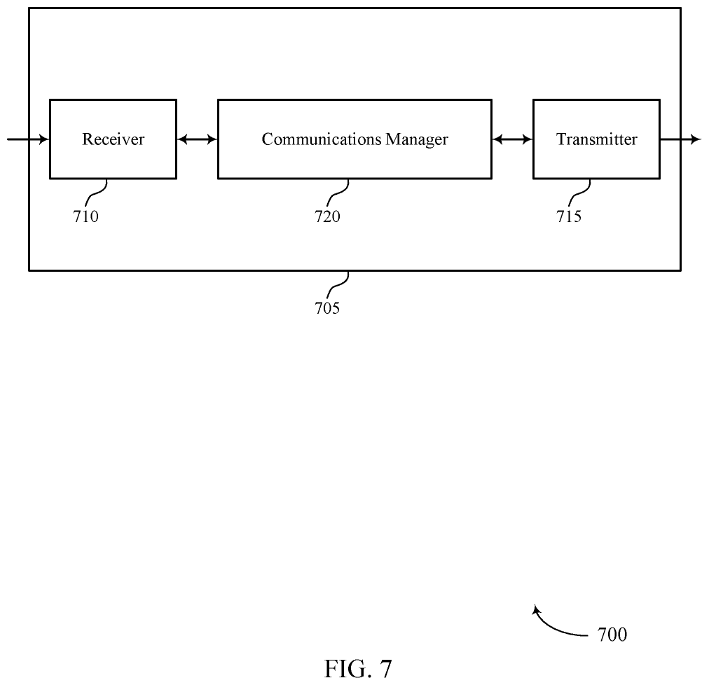

FIG. 7 illustrates a block diagram 700 of a device 705 that supports feedback processes for energy harvesting devices in accordance with one or more aspects of the present disclosure. The device 705 may be an example of aspects of a UE 115 or an energy harvesting device as described herein. The device 705 may include a receiver 710, a transmitter 715, and a communications manager 720. The device 705 may also include one or more processors, memory coupled with the one or more processors, and instructions stored in the memory that are executable by the one or more processors to enable the one or more processors to perform the feedback processes for energy harvesting devices features discussed herein. Each of these components may be in communication with one another (e.g., via one or more buses).

The receiver 710 may provide a means for receiving information such as packets, user data, control information, or any combination thereof associated with various information channels (for example, control channels, data channels, information channels related to feedback processes for energy harvesting devices). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (for example, control channels, data channels, information channels related to feedback processes for energy harvesting devices). In some implementations, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of feedback processes for energy harvesting devices as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at an energy harvesting wireless device in accordance with examples as disclosed herein. For example, the communications manager 720 may be configured as or otherwise support a means for transmitting energy status information for the energy harvesting wireless device, where the energy harvesting wireless device cycles between an energy harvesting mode and a wireless communication mode. The communications manager 720 may be configured as or otherwise support a means for receiving, during the wireless communication mode, control signaling indicating to apply a first feedback process type of a set of multiple different feedback process types based on the energy status information. The communications manager 720 may be configured as or otherwise support a means for receiving a control message scheduling transmission of a message to the energy harvesting wireless device in a resource of a shared data channel. The communications manager 720 may be configured as or otherwise support a means for monitoring the resource for the message based on the control message. The communications manager 720 may be configured as or otherwise support a means for transmitting feedback information for the message in accordance with the indicated first feedback process type.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reducing power consumption at an energy harvesting device, for example, by reducing errors in retransmissions of a message. The device 705 may also reduce processing at the energy harvesting device or a transmitting device by reducing a quantity of HARQ processes performed in error.

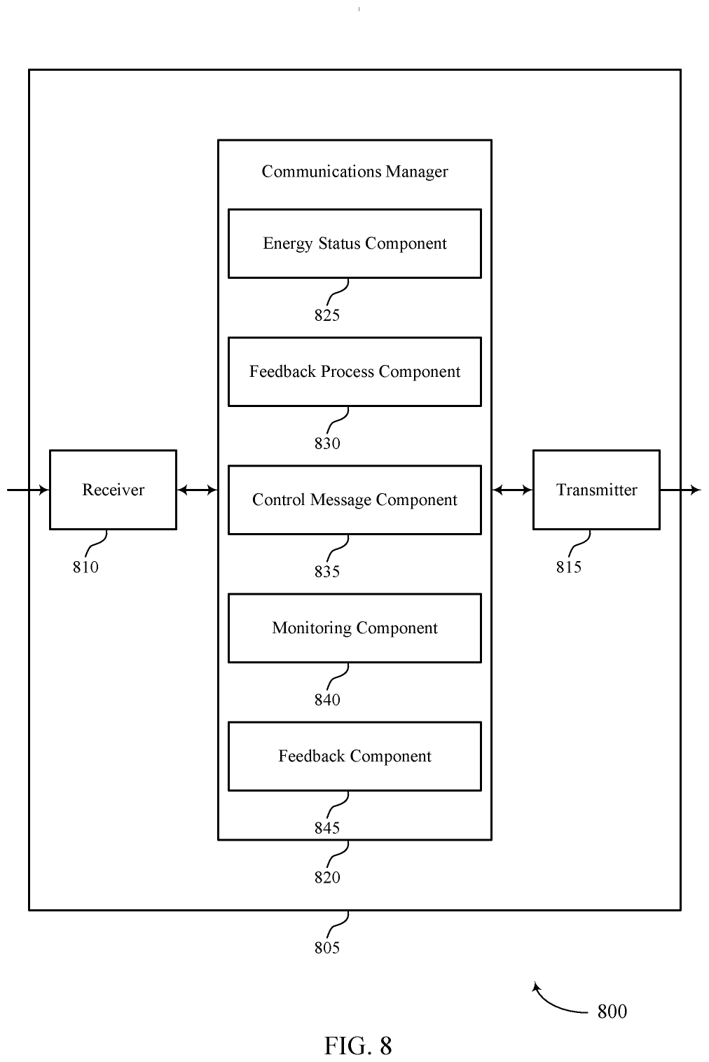

FIG. 8 illustrates a block diagram 800 of a device 805 that supports feedback processes for energy harvesting devices in accordance with one or more aspects of the present disclosure. The device 805 may be an example of aspects of a device 705, a UE 115, or an energy harvesting device as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (for example, control channels, data channels, information channels related to feedback processes for energy harvesting devices). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (for example, control channels, data channels, information channels related to feedback processes for energy harvesting devices). In some implementations, the transmitter 815 may be co-located with a receiver 810 in a transceiver module. The transmitter 815 may utilize a single antenna or a set of multiple antennas.

The device 805, or various components thereof, may be an example of means for performing various aspects of feedback processes for energy harvesting devices as described herein. For example, the communications manager 820 may include an energy status component 825, a feedback process component 830, a control message component 835, a monitoring component 840, a feedback component 845, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at an energy harvesting wireless device in accordance with examples as disclosed herein. The energy status component 825 may be configured as or otherwise support a means for transmitting energy status information for the energy harvesting wireless device, where the energy harvesting wireless device cycles between an energy harvesting mode and a wireless communication mode. The feedback process component 830 may be configured as or otherwise support a means for receiving, during the wireless communication mode, control signaling indicating to apply a first feedback process type of a set of multiple different feedback process types based on the energy status information. The control message component 835 may be configured as or otherwise support a means for receiving a control message scheduling transmission of a message to the energy harvesting wireless device in a resource of a shared data channel. The monitoring component 840 may be configured as or otherwise support a means for monitoring the resource for the message based on the control message. The feedback component 845 may be configured as or otherwise support a means for transmitting feedback information for the message in accordance with the indicated first feedback process type.

In some cases, the energy status component 825, the feedback process component 830, the control message component 835, the monitoring component 840, and the feedback component 845 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the energy status component 825, the feedback process component 830, the control message component 835, the monitoring component 840, and the feedback component 845 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

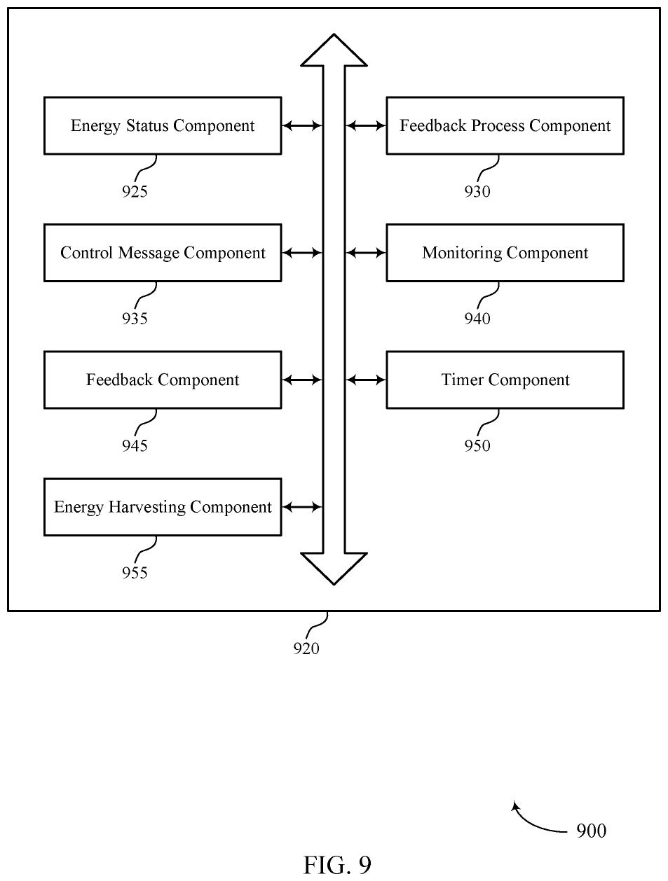

FIG. 9 illustrates a block diagram 900 of a communications manager 920 that supports feedback processes for energy harvesting devices in accordance with one or more aspects of the present disclosure. The communications manager 920 may be an example of aspects of a communications manager 720, a communications manager 820, or both, as described herein. The communications manager 920, or various components thereof, may be an example of means for performing various aspects of feedback processes for energy harvesting devices as described herein. For example, the communications manager 920 may include an energy status component 925, a feedback process component 930, a control message component 935, a monitoring component 940, a feedback component 945, a timer component 950, an energy harvesting component 955, or any combination thereof. Each of these components may communicate, directly or indirectly, with one another (e.g., via one or more buses).

The communications manager 920 may support wireless communication at an energy harvesting wireless device in accordance with examples as disclosed herein. The energy status component 925 may be configured as or otherwise support a means for transmitting energy status information for the energy harvesting wireless device, where the energy harvesting wireless device cycles between an energy harvesting mode and a wireless communication mode. The feedback process component 930 may be configured as or otherwise support a means for receiving, during the wireless communication mode, control signaling indicating to apply a first feedback process type of a set of multiple different feedback process types based on the energy status information. The control message component 935 may be configured as or otherwise support a means for receiving a control message scheduling transmission of a message to the energy harvesting wireless device in a resource of a shared data channel. The monitoring component 940 may be configured as or otherwise support a means for monitoring the resource for the message based on the control message. The feedback component 945 may be configured as or otherwise support a means for transmitting feedback information for the message in accordance with the indicated first feedback process type.

In some examples, the energy status component 925 may be configured as or otherwise support a means for transmitting updated energy status information for the energy harvesting wireless device. In some examples, the feedback process component 930 may be configured as or otherwise support a means for receiving the control signaling indicating to change from applying the first feedback process type to a second feedback process type based on the updated energy status information, where the first feedback process type includes a HARQ process and the second feedback process type includes an ARQ process.

In some examples, the feedback process component 930 may be configured as or otherwise support a means for transmitting a report indicating a quantity of HARQ processes supported by the energy harvesting wireless device, where the quantity of HARQ processes indicates the first feedback process type. In some examples, the report indicates a maximum quantity of HARQ processes.

In some examples, the monitoring component 940 may be configured as or otherwise support a means for monitoring for a retransmission of the message based on an expiration of an RTT timer.

In some examples, the feedback process component 930 may be configured as or otherwise support a means for receiving a low-power signal indicating a change to an RTT timer, a retransmission timer, or both. In some examples, the feedback process component 930 may be configured as or otherwise support a means for receiving capability signaling indicating a capability to support the change to the RTT timer, the retransmission timer, or both.

In some examples, the timer component 950 may be configured as or otherwise support a means for transmitting a message indicating a set of multiple RTT timers, where an RTT timer of the set of multiple RTT timers is based on the energy status information.

In some examples, the timer component 950 may be configured as or otherwise support a means for starting an RTT timer based on transmitting the feedback information, where a duration of the RTT timer is based on the energy status information.

In some examples, the monitoring component 940 may be configured as or otherwise support a means for monitoring a control channel for receiving a retransmission of the message during a duration of a retransmission timer. In some examples, the energy harvesting component 955 may be configured as or otherwise support a means for performing energy harvesting during the duration of the retransmission timer and based on entering an energy harvesting mode. In some examples, the timer component 950 may be configured as or otherwise support a means for suspending the retransmission timer based on entering the energy harvesting mode.

In some examples, to support receiving the control signaling, the feedback process component 930 may be configured as or otherwise support a means for receiving the control signaling indicating a quantity of HARQ processes based on the energy status information.

In some examples, the feedback process component 930 may be configured as or otherwise support a means for receiving a request to increase a quantity of HARQ processes based on the energy status information.

In some examples, the feedback information indicates one or more symbols of the message the energy harvesting wireless device failed to receive, and the control message component 935 may be configured as or otherwise support a means for receiving a second control message that indicates a HARQ process and the one or more symbols based on the feedback information.

In some examples, to support receiving the second control message, the control message component 935 may be configured as or otherwise support a means for receiving the second control message that indicates a bitmap, where the bitmap indicates the one or more symbols.

In some examples, to support transmitting the energy status information, the energy status component 925 may be configured as or otherwise support a means for transmitting the energy status information indicating that the energy harvesting wireless device corresponds to a class of wireless devices that support energy harvesting.

In some examples, the energy status information includes an energy status profile, a charging rate profile, a discharging rate profile, a battery leakage rate profile, or a combination thereof.

In some cases, the energy status component 925, the feedback process component 930, the control message component 935, the monitoring component 940, the feedback component 945, the timer component 950, and the energy harvesting component 955 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the energy status component 925, the feedback process component 930, the control message component 935, the monitoring component 940, the feedback component 945, the timer component 950, and the energy harvesting component 955 discussed herein.

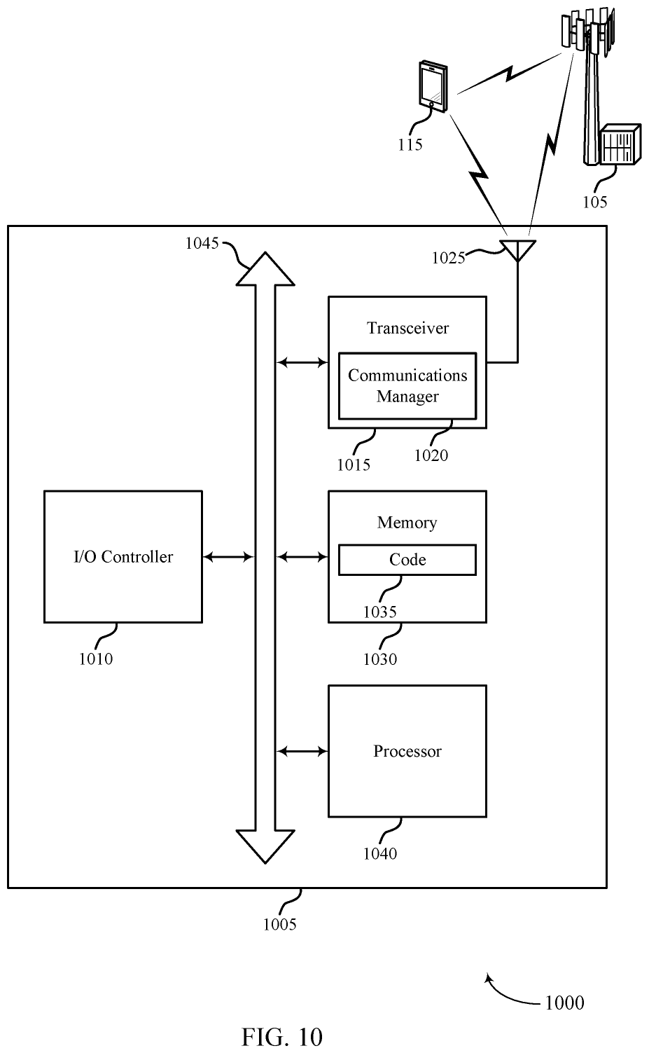

FIG. 10 illustrates a diagram of a system 1000 including a device 1005 that supports feedback processes for energy harvesting devices in accordance with one or more aspects of the present disclosure. The device 1005 may be an example of or include the components of a device 705, a device 805, or a UE 115 as described herein. The device 1005 may communicate (e.g., wirelessly) with one or more network nodes 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 also may manage peripherals not integrated into the device 1005. In some implementations, the I/O controller 1010 may represent a physical connection or port to an external peripheral. In some implementations, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some implementations, the I/O controller 1010 may be implemented as part of a processor or processing system, such as the processor 1040. In some implementations, a user may interact with the device 1005 via the I/O controller 1010 or via hardware components controlled by the I/O controller 1010.

In some implementations, the device 1005 may include a single antenna 1025. However, in some other implementations, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 also may include a modem to modulate the packets, to provide the modulated packets to one or more antennas 1025 for transmission, and to demodulate packets received from the one or more antennas 1025. In some implementations, the transceiver 1015 may include one or more interfaces, such as one or more interfaces coupled with the one or more antennas 1025 that are configured to support various receiving or obtaining operations, or one or more interfaces coupled with the one or more antennas 1025 that are configured to support various transmitting or outputting operations, or a combination thereof. In some implementations, the transceiver 1015 may include or be configured for coupling with one or more processors or memory components that are operable to perform or support operations based on received or obtained information or signals, or to generate information or other signals for transmission or other outputting, or any combination thereof. In some implementations, the transceiver 1015, or the transceiver 1015 and the one or more antennas 1025, or the transceiver 1015 and the one or more antennas 1025 and one or more processors or memory components (for example, the processor 1040, or the memory 1030, or both), may be included in a chip or chip assembly that is installed in the device 1005.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some implementations, the code 1035 may not be directly executable by the processor 1040 but may cause a computer (for example, when compiled and executed) to perform functions described herein. In some implementations, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting feedback processes for energy harvesting devices). For example, the device 1005 or a component of the device 1005 may include a processor 1040 and memory 1030 coupled with the processor 1040, the processor 1040 and memory 1030 configured to perform various functions described herein. The processor 1040 may be an example of a cloud-computing platform (e.g., one or more physical nodes and supporting software such as operating systems, virtual machines, or container instances) that may host the functions (e.g., by executing code 1035) to perform the functions of the device 1005. The processor 1040 may be any one or more suitable processors capable of executing scripts or instructions of one or more software programs stored in the device 1005 (such as within the memory 1030). In some implementations, the processor 1040 may be a component of a processing system. A processing system may generally refer to a system or series of machines or components that receives inputs and processes the inputs to produce a set of outputs (which may be passed to other systems or components of, for example, the device 1005). For example, a processing system of the device 1005 may refer to a system including the various other components or subcomponents of the device 1005, such as the processor 1040, or the transceiver 1015, or the communications manager 1020, or other components or combinations of components of the device 1005. The processing system of the device 1005 may interface with other components of the device 1005, and may process information received from other components (such as inputs or signals) or output information to other components. For example, a chip or modem of the device 1005 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1005 may transmit information output from the chip or modem. Additionally, or alternatively, in some implementations, the one or more interfaces may refer to an interface between the processing system of the chip or modem and a receiver, such that the device 1005 may obtain information or signal inputs, and the information may be passed to the processing system. A person having ordinary skill in the art will readily recognize that a first interface also may obtain information or signal inputs, and a second interface also may output information or signal outputs.

The communications manager 1020 may support wireless communication at an energy harvesting wireless device in accordance with examples as disclosed herein. For example, the communications manager 1020 may be configured as or otherwise support a means for transmitting energy status information for the energy harvesting wireless device, where the energy harvesting wireless device cycles between an energy harvesting mode and a wireless communication mode. The communications manager 1020 may be configured as or otherwise support a means for receiving, during the wireless communication mode, control signaling indicating to apply a first feedback process type of a set of multiple different feedback process types based on the energy status information. The communications manager 1020 may be configured as or otherwise support a means for receiving a control message scheduling transmission of a message to the energy harvesting wireless device in a resource of a shared data channel. The communications manager 1020 may be configured as or otherwise support a means for monitoring the resource for the message based on the control message. The communications manager 1020 may be configured as or otherwise support a means for transmitting feedback information for the message in accordance with the indicated first feedback process type.

By including or configuring the communications manager 1020 in accordance with examples as described herein, the device 1005 may support techniques for improved communication reliability by extending RTT or retransmission timers allowing more time for an energy harvesting device to harvest sufficient energy before receiving a retransmission of a message, which may reduce errors in data that the energy harvesting device receives. In some examples, the device 1005 may support improved coordination between devices by supporting low power signals that may be received by a wakeup receiver of an energy harvesting device where a main receiver of the energy harvesting device may be inactive or in a sleep mode.

In some implementations, the communications manager 1020 may be configured to perform various operations (for example, receiving, monitoring, transmitting) using or otherwise in cooperation with the transceiver 1015, the one or more antennas 1025, or any combination thereof. Although the communications manager 1020 is illustrated as a component of the transceiver 1015, in some implementations, one or more functions described with reference to the communications manager 1020 may be supported by or performed by the transceiver 1015, the processor 1040, the memory 1030, the code 1035, or any combination thereof. For example, the code 1035 may include instructions executable by the processor 1040 to cause the device 1005 to perform various aspects of feedback processes for energy harvesting devices as described herein, or the processor 1040 and the memory 1030 may be otherwise configured to perform or support such operations.

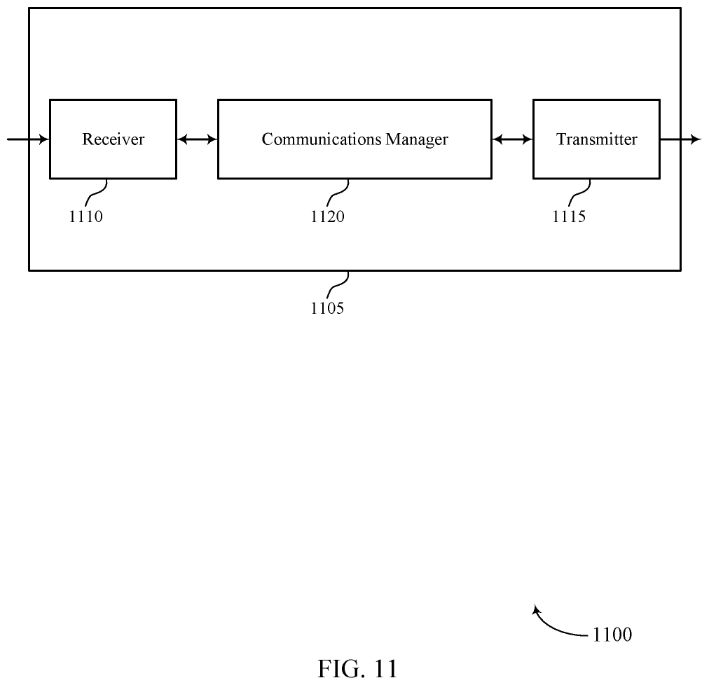

FIG. 11 illustrates a block diagram 1100 of a device 1105 that supports feedback processes for energy harvesting devices in accordance with one or more aspects of the present disclosure. The device 1105 may be an example of aspects of a network node 105 as described herein. The device 1105 may include a receiver 1110, a transmitter 1115, and a communications manager 1120. The device 1105 may also include one or more processors, memory coupled with the one or more processors, and instructions stored in the memory that are executable by the one or more processors to enable the one or more processors to perform the feedback processes for energy harvesting devices features discussed herein. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of feedback processes for energy harvesting devices as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network node in accordance with examples as disclosed herein. For example, the communications manager 1120 may be configured as or otherwise support a means for receiving energy status information for an energy harvesting wireless device, where the energy harvesting wireless device cycles between an energy harvesting mode and a wireless communication mode. The communications manager 1120 may be configured as or otherwise support a means for transmitting control signaling indicating to apply a first feedback process type of a set of multiple different feedback process types based on the energy status information. The communications manager 1120 may be configured as or otherwise support a means for transmitting a control message scheduling transmission of a message to the energy harvesting wireless device in a resource of a shared data channel. The communications manager 1120 may be configured as or otherwise support a means for transmitting the message based on the control message. The communications manager 1120 may be configured as or otherwise support a means for receiving feedback information for the message in accordance with the indicated first feedback process type.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for reducing power consumption at an energy harvesting device, for example, by reducing errors in retransmissions of a message. The device 1105 may also reduce processing at the energy harvesting device or a transmitting device by reducing a quantity of HARQ processes performed in error.

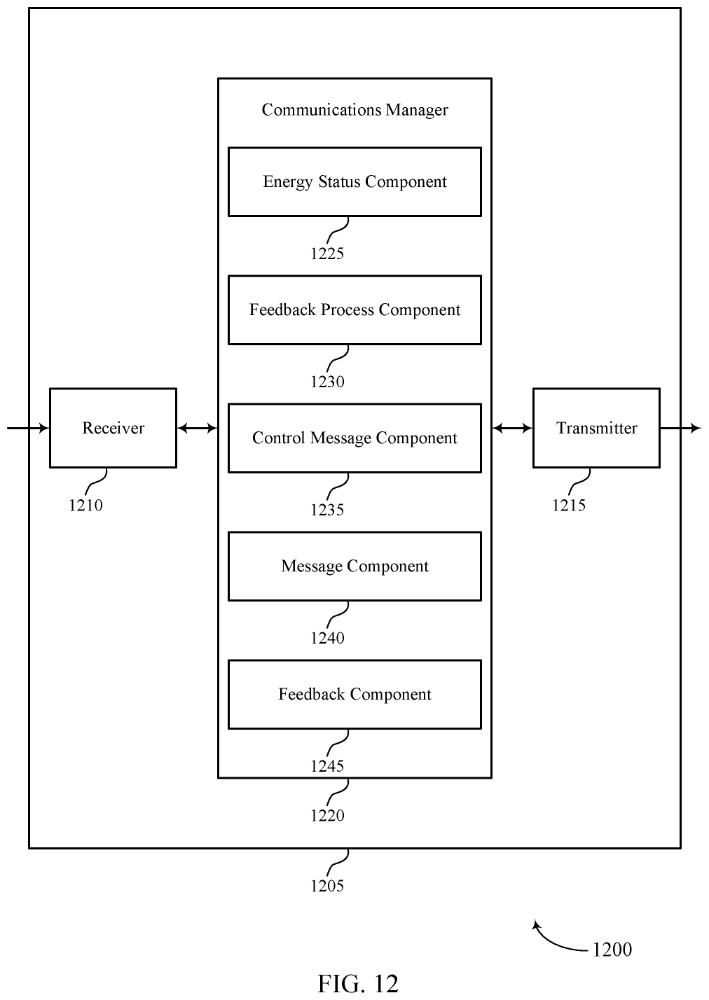

FIG. 12 illustrates a block diagram 1200 of a device 1205 that supports feedback processes for energy harvesting devices in accordance with one or more aspects of the present disclosure. The device 1205 may be an example of aspects of a device 1105 or a network node 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of feedback processes for energy harvesting devices as described herein. For example, the communications manager 1220 may include an energy status manager 1225, a feedback process manager 1230, a control message manager 1235, a message manager 1240, a feedback manager 1245, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network node in accordance with examples as disclosed herein. The energy status manager 1225 may be configured as or otherwise support a means for receiving energy status information for an energy harvesting wireless device, where the energy harvesting wireless device cycles between an energy harvesting mode and a wireless communication mode. The feedback process manager 1230 may be configured as or otherwise support a means for transmitting control signaling indicating to apply a first feedback process type of a set of multiple different feedback process types based on the energy status information. The control message manager 1235 may be configured as or otherwise support a means for transmitting a control message scheduling transmission of a message to the energy harvesting wireless device in a resource of a shared data channel. The message manager 1240 may be configured as or otherwise support a means for transmitting the message based on the control message. The feedback manager 1245 may be configured as or otherwise support a means for receiving feedback information for the message in accordance with the indicated first feedback process type.

In some cases, the energy status manager 1225, the feedback process manager 1230, the control message manager 1235, the message manager 1240, and the feedback manager 1245 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the energy status manager 1225, the feedback process manager 1230, the control message manager 1235, the message manager 1240, and the feedback manager 1245 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

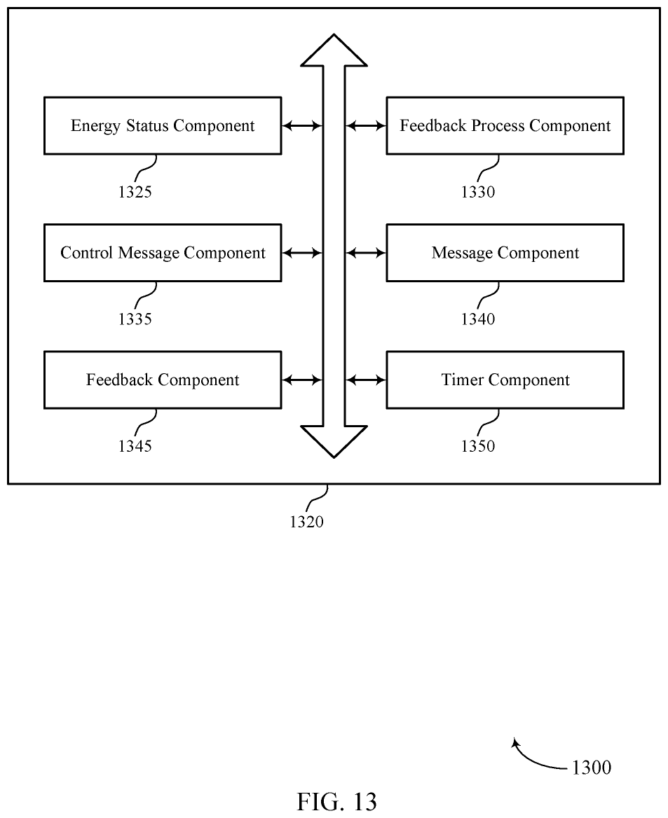

FIG. 13 illustrates a block diagram 1300 of a communications manager 1320 that supports feedback processes for energy harvesting devices in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of feedback processes for energy harvesting devices as described herein. For example, the communications manager 1320 may include an energy status manager 1325, a feedback process manager 1330, a control message manager 1335, a message manager 1340, a feedback manager 1345, a timer manager 1350, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network node 105, between devices, components, or virtualized components associated with a network node 105), or any combination thereof.

The communications manager 1320 may support wireless communication at a network node in accordance with examples as disclosed herein. The energy status manager 1325 may be configured as or otherwise support a means for receiving energy status information for an energy harvesting wireless device, where the energy harvesting wireless device cycles between an energy harvesting mode and a wireless communication mode. The feedback process manager 1330 may be configured as or otherwise support a means for transmitting control signaling indicating to apply a first feedback process type of a set of multiple different feedback process types based on the energy status information. The control message manager 1335 may be configured as or otherwise support a means for transmitting a control message scheduling transmission of a message to the energy harvesting wireless device in a resource of a shared data channel. The message manager 1340 may be configured as or otherwise support a means for transmitting the message based on the control message. The feedback manager 1345 may be configured as or otherwise support a means for receiving feedback information for the message in accordance with the indicated first feedback process type.

In some examples, the energy status manager 1325 may be configured as or otherwise support a means for receiving updated energy status information for the energy harvesting wireless device. In some examples, the feedback process manager 1330 may be configured as or otherwise support a means for transmitting the control signaling indicating to change from applying the first feedback process type to a second feedback process type based on the updated energy status information, where the first feedback process type includes a HARQ process and the second feedback process type includes an ARQ process.

In some examples, the feedback process manager 1330 may be configured as or otherwise support a means for receiving a report indicating a quantity of HARQ processes supported by the energy harvesting wireless device, where the quantity of HARQ processes indicates the first feedback process type. In some examples, the report indicates a maximum quantity of HARQ processes.

In some examples, the message manager 1340 may be configured as or otherwise support a means for transmitting a retransmission of the message based on an expiration of an RTT timer.

In some examples, the feedback process manager 1330 may be configured as or otherwise support a means for transmitting a low-power signal indicating a change to an RTT timer, a retransmission timer, or both. In some examples, the feedback process manager 1330 may be configured as or otherwise support a means for transmitting capability signaling indicating a capability to support the change to the RTT timer, the retransmission timer, or both.

In some examples, the timer manager 1350 may be configured as or otherwise support a means for receiving a message indicating a set of multiple RTT timers, where an RTT timer of the set of multiple RTT timers is based on the energy status information.

In some examples, the timer manager 1350 may be configured as or otherwise support a means for starting an RTT timer based on transmitting the feedback information, where a duration of the RTT timer is based on the energy status information.

In some examples, the message manager 1340 may be configured as or otherwise support a means for transmitting a retransmission of the message via a control channel during a duration of a retransmission timer. In some examples, the timer manager 1350 may be configured as or otherwise support a means for suspending the retransmission timer based on the energy harvesting wireless device entering an energy harvesting mode.

In some examples, to support transmitting the control signaling, the feedback process manager 1330 may be configured as or otherwise support a means for transmitting the control signaling indicating a quantity of HARQ processes based on the energy status information.

In some examples, the feedback process manager 1330 may be configured as or otherwise support a means for transmitting a request to increase a quantity of HARQ processes based on the energy status information.

In some examples, the feedback information indicates one or more symbols of the message the energy harvesting wireless device failed to receive, and the control message manager 1335 may be configured as or otherwise support a means for transmitting a second control message that indicates a HARQ process and the one or more symbols based on the feedback information.

In some examples, to support transmitting the second control message, the control message manager 1335 may be configured as or otherwise support a means for transmitting the second control message that indicates a bitmap, where the bitmap indicates the one or more symbols.

In some examples, the message manager 1340 may be configured as or otherwise support a means for rescheduling transmission of the one or more symbols that the energy harvesting wireless device failed to receive.

In some examples, to support receiving the energy status information, the energy status manager 1325 may be configured as or otherwise support a means for receiving the energy status information indicating that the energy harvesting wireless device corresponds to a class of wireless devices that support energy harvesting.

In some examples, the energy status information includes an energy status profile, a charging rate profile, a discharging rate profile, a battery leakage rate profile, or a combination thereof.

In some cases, the energy status manager 1325, the feedback process manager 1330, the control message manager 1335, the message manager 1340, the feedback manager 1345, and the timer manager 1350 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the energy status manager 1325, the feedback process manager 1330, the control message manager 1335, the message manager 1340, the feedback manager 1345, and the timer manager 1350 discussed herein.

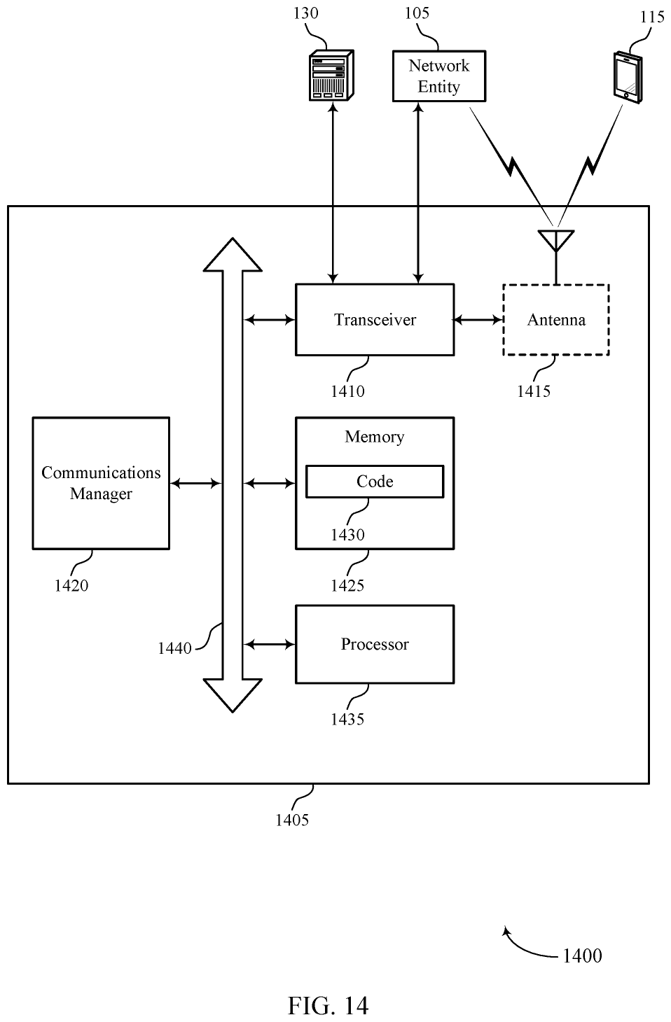

FIG. 14 illustrates a diagram of a system 1400 including a device 1405 that supports feedback processes for energy harvesting devices in accordance with one or more aspects of the present disclosure. The device 1405 may be an example of or include the components of a device 1105, a device 1205, or a network node 105 as described herein. The device 1405 may communicate with one or more network nodes 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting feedback processes for energy harvesting devices). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network nodes 105, and may include a controller or scheduler for controlling communications with UEs 115 in cooperation with other network nodes 105. In some examples, the communications manager 1420 may support an X2 interface within an LTE/LTE-A wireless communications network technology to provide communication between network nodes 105.

The communications manager 1420 may support wireless communication at a network node in accordance with examples as disclosed herein. For example, the communications manager 1420 may be configured as or otherwise support a means for receiving energy status information for an energy harvesting wireless device, where the energy harvesting wireless device cycles between an energy harvesting mode and a wireless communication mode. The communications manager 1420 may be configured as or otherwise support a means for transmitting control signaling indicating to apply a first feedback process type of a set of multiple different feedback process types based on the energy status information. The communications manager 1420 may be configured as or otherwise support a means for transmitting a control message scheduling transmission of a message to the energy harvesting wireless device in a resource of a shared data channel. The communications manager 1420 may be configured as or otherwise support a means for transmitting the message based on the control message. The communications manager 1420 may be configured as or otherwise support a means for receiving feedback information for the message in accordance with the indicated first feedback process type.

By including or configuring the communications manager 1420 in accordance with examples as described herein, the device 1405 may support techniques for improved communication reliability by extending RTT or retransmission timers allowing more time for an energy harvesting device to harvest sufficient energy before receiving a retransmission of a message, which may reduce errors in data that the energy harvesting device receives. In some examples, the device 1405 may support improved coordination between devices by supporting low power signals that may be received by a wakeup receiver of an energy harvesting device where a main receiver of the energy harvesting device may be inactive or in a sleep mode.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of feedback processes for energy harvesting devices as described herein, or the processor 1435 and the memory 1425 may be otherwise configured to perform or support such operations.

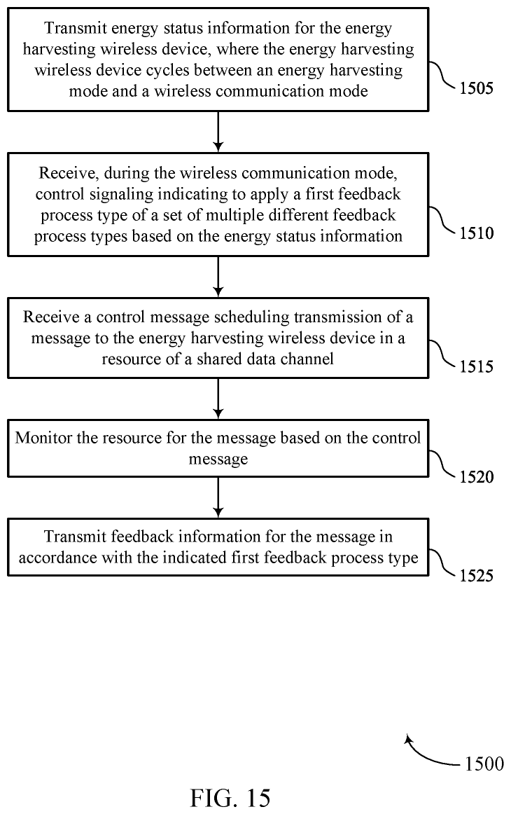

FIG. 15 illustrates a flowchart showing a method 1500 that supports feedback processes for energy harvesting devices in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include transmitting energy status information for the energy harvesting wireless device, where the energy harvesting wireless device cycles between an energy harvesting mode and a wireless communication mode. The operations of 1505 may be performed in accordance with examples as disclosed herein. In some examples, aspects of the operations of 1505 may be performed by an energy status component 925 as described with reference to FIG. 9.

At 1510, the method may include receiving, during the wireless communication mode, control signaling indicating to apply a first feedback process type of a set of multiple different feedback process types based on the energy status information. The operations of 1510 may be performed in accordance with examples as disclosed herein. In some examples, aspects of the operations of 1510 may be performed by a feedback process component 930 as described with reference to FIG. 9.

At 1515, the method may include receiving a control message scheduling transmission of a message to the energy harvesting wireless device in a resource of a shared data channel. The operations of 1515 may be performed in accordance with examples as disclosed herein. In some examples, aspects of the operations of 1515 may be performed by a control message component 935 as described with reference to FIG. 9.

At 1520, the method may include monitoring the resource for the message based on the control message. The operations of 1520 may be performed in accordance with examples as disclosed herein. In some examples, aspects of the operations of 1520 may be performed by a monitoring component 940 as described with reference to FIG. 9.

At 1525, the method may include transmitting feedback information for the message in accordance with the indicated first feedback process type. The operations of 1525 may be performed in accordance with examples as disclosed herein. In some examples, aspects of the operations of 1525 may be performed by a feedback component 945 as described with reference to FIG. 9.

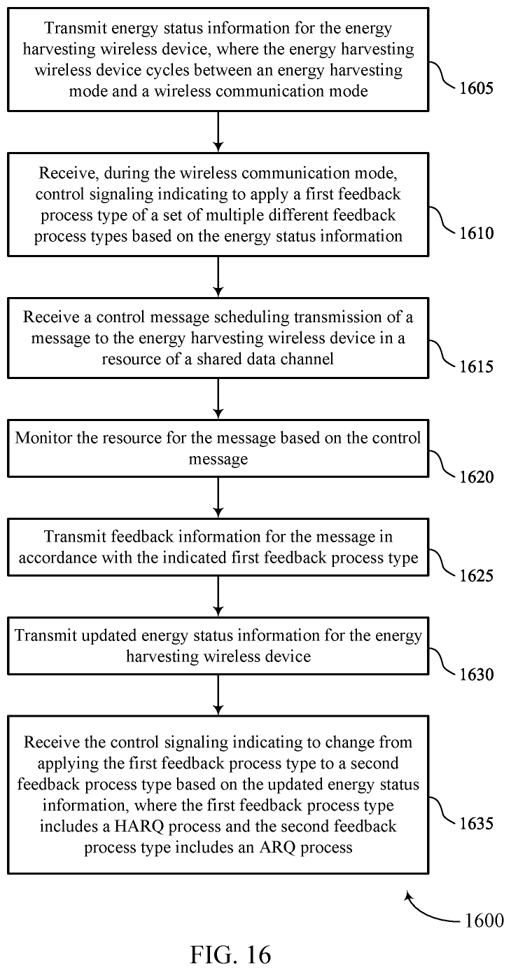

FIG. 16 illustrates a flowchart showing a method 1600 that supports feedback processes for energy harvesting devices in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include transmitting energy status information for the energy harvesting wireless device, where the energy harvesting wireless device cycles between an energy harvesting mode and a wireless communication mode. The operations of 1605 may be performed in accordance with examples as disclosed herein. In some examples, aspects of the operations of 1605 may be performed by an energy status component 925 as described with reference to FIG. 9.

At 1610, the method may include receiving, during the wireless communication mode, control signaling indicating to apply a first feedback process type of a set of multiple different feedback process types based on the energy status information. The operations of 1610 may be performed in accordance with examples as disclosed herein. In some examples, aspects of the operations of 1610 may be performed by a feedback process component 930 as described with reference to FIG. 9.

At 1615, the method may include receiving a control message scheduling transmission of a message to the energy harvesting wireless device in a resource of a shared data channel. The operations of 1615 may be performed in accordance with examples as disclosed herein. In some examples, aspects of the operations of 1615 may be performed by a control message component 935 as described with reference to FIG. 9.

At 1620, the method may include monitoring the resource for the message based on the control message. The operations of 1620 may be performed in accordance with examples as disclosed herein. In some examples, aspects of the operations of 1620 may be performed by a monitoring component 940 as described with reference to FIG. 9.

At 1625, the method may include transmitting feedback information for the message in accordance with the indicated first feedback process type. The operations of 1625 may be performed in accordance with examples as disclosed herein. In some examples, aspects of the operations of 1625 may be performed by a feedback component 945 as described with reference to FIG. 9.

At 1630, the method may include transmitting updated energy status information for the energy harvesting wireless device. The operations of 1630 may be performed in accordance with examples as disclosed herein. In some examples, aspects of the operations of 1630 may be performed by an energy status component 925 as described with reference to FIG. 9.

At 1635, the method may include receiving the control signaling indicating to change from applying the first feedback process type to a second feedback process type based on the updated energy status information, where the first feedback process type includes a HARQ process and the second feedback process type includes an ARQ process. The operations of 1635 may be performed in accordance with examples as disclosed herein. In some examples, aspects of the operations of 1635 may be performed by a feedback process component 930 as described with reference to FIG. 9.

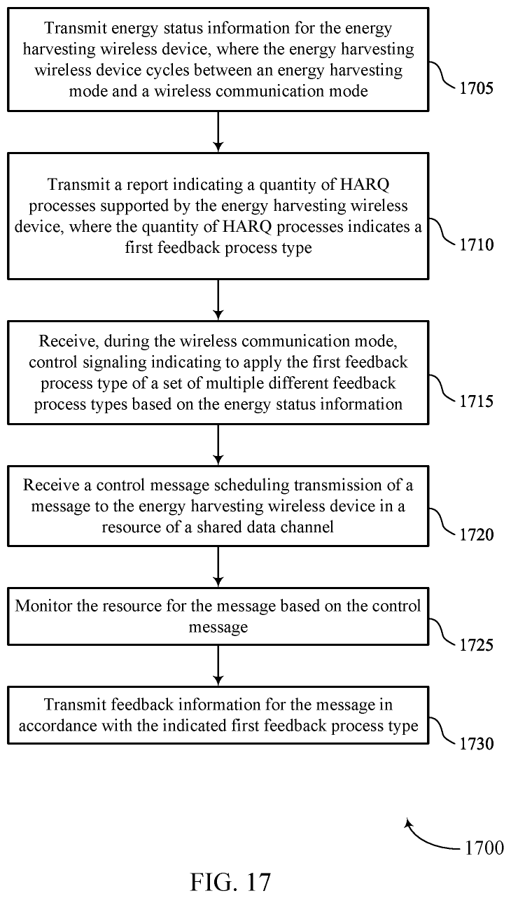

FIG. 17 illustrates a flowchart showing a method 1700 that supports feedback processes for energy harvesting devices in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include transmitting energy status information for the energy harvesting wireless device, where the energy harvesting wireless device cycles between an energy harvesting mode and a wireless communication mode. The operations of 1705 may be performed in accordance with examples as disclosed herein. In some examples, aspects of the operations of 1705 may be performed by an energy status component 925 as described with reference to FIG. 9.

At 1710, the method may include transmitting a report indicating a quantity of HARQ processes supported by the energy harvesting wireless device, where the quantity of HARQ processes indicates a first feedback process type. The operations of 1710 may be performed in accordance with examples as disclosed herein. In some examples, aspects of the operations of 1710 may be performed by a feedback process component 930 as described with reference to FIG. 9.

At 1715, the method may include receiving, during the wireless communication mode, control signaling indicating to apply the first feedback process type of a set of multiple different feedback process types based on the energy status information. The operations of 1715 may be performed in accordance with examples as disclosed herein. In some examples, aspects of the operations of 1715 may be performed by a feedback process component 930 as described with reference to FIG. 9.

At 1720, the method may include receiving a control message scheduling transmission of a message to the energy harvesting wireless device in a resource of a shared data channel. The operations of 1720 may be performed in accordance with examples as disclosed herein. In some examples, aspects of the operations of 1720 may be performed by a control message component 935 as described with reference to FIG. 9.

At 1725, the method may include monitoring the resource for the message based on the control message. The operations of 1725 may be performed in accordance with examples as disclosed herein. In some examples, aspects of the operations of 1725 may be performed by a monitoring component 940 as described with reference to FIG. 9.

At 1730, the method may include transmitting feedback information for the message in accordance with the indicated first feedback process type. The operations of 1730 may be performed in accordance with examples as disclosed herein. In some examples, aspects of the operations of 1730 may be performed by a feedback component 945 as described with reference to FIG. 9.

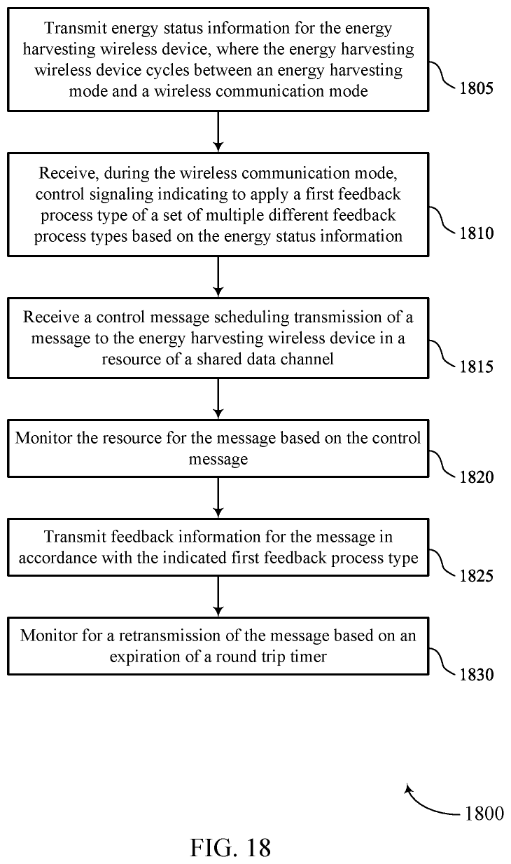

FIG. 18 illustrates a flowchart showing a method 1800 that supports feedback processes for energy harvesting devices in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include transmitting energy status information for the energy harvesting wireless device, where the energy harvesting wireless device cycles between an energy harvesting mode and a wireless communication mode. The operations of 1805 may be performed in accordance with examples as disclosed herein. In some examples, aspects of the operations of 1805 may be performed by an energy status component 925 as described with reference to FIG. 9.

At 1810, the method may include receiving, during the wireless communication mode, control signaling indicating to apply a first feedback process type of a set of multiple different feedback process types based on the energy status information. The operations of 1810 may be performed in accordance with examples as disclosed herein. In some examples, aspects of the operations of 1810 may be performed by a feedback process component 930 as described with reference to FIG. 9.

At 1815, the method may include receiving a control message scheduling transmission of a message to the energy harvesting wireless device in a resource of a shared data channel. The operations of 1815 may be performed in accordance with examples as disclosed herein. In some examples, aspects of the operations of 1815 may be performed by a control message component 935 as described with reference to FIG. 9.

At 1820, the method may include monitoring the resource for the message based on the control message. The operations of 1820 may be performed in accordance with examples as disclosed herein. In some examples, aspects of the operations of 1820 may be performed by a monitoring component 940 as described with reference to FIG. 9.

At 1825, the method may include transmitting feedback information for the message in accordance with the indicated first feedback process type. The operations of 1825 may be performed in accordance with examples as disclosed herein. In some examples, aspects of the operations of 1825 may be performed by a feedback component 945 as described with reference to FIG. 9.

At 1830, the method may include monitoring for a retransmission of the message based on an expiration of an RTT timer. The operations of 1830 may be performed in accordance with examples as disclosed herein. In some examples, aspects of the operations of 1830 may be performed by a monitoring component 940 as described with reference to FIG. 9.

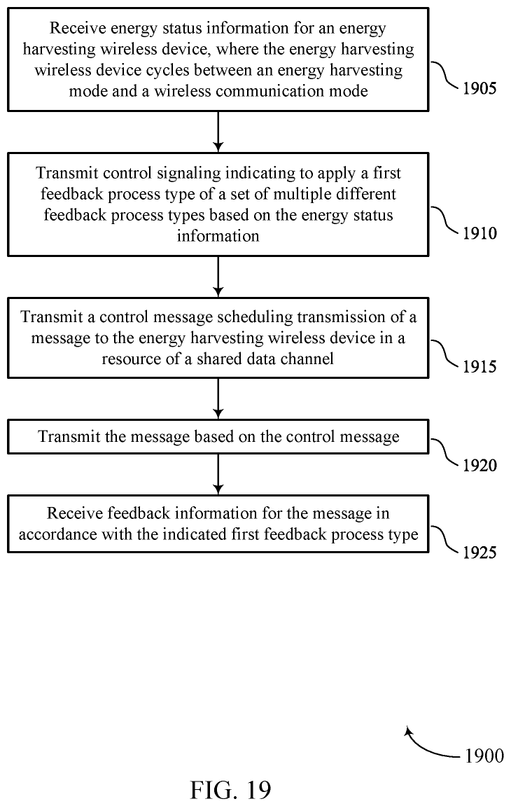

FIG. 19 illustrates a flowchart showing a method 1900 that supports feedback processes for energy harvesting devices in accordance with one or more aspects of the present disclosure. The operations of the method 1900 may be implemented by a network node or its components as described herein. For example, the operations of the method 1900 may be performed by a network node as described with reference to FIGS. 1 through 6 and 11 through 14. In some examples, a network node may execute a set of instructions to control the functional elements of the network node to perform the described functions. Additionally, or alternatively, the network node may perform aspects of the described functions using special-purpose hardware.

At 1905, the method may include receiving energy status information for an energy harvesting wireless device, where the energy harvesting wireless device cycles between an energy harvesting mode and a wireless communication mode. The operations of 1905 may be performed in accordance with examples as disclosed herein. In some examples, aspects of the operations of 1905 may be performed by an energy status manager 1325 as described with reference to FIG. 13.

At 1910, the method may include transmitting control signaling indicating to apply a first feedback process type of a set of multiple different feedback process types based on the energy status information. The operations of 1910 may be performed in accordance with examples as disclosed herein. In some examples, aspects of the operations of 1910 may be performed by a feedback process manager 1330 as described with reference to FIG. 13.

At 1915, the method may include transmitting a control message scheduling transmission of a message to the energy harvesting wireless device in a resource of a shared data channel. The operations of 1915 may be performed in accordance with examples as disclosed herein. In some examples, aspects of the operations of 1915 may be performed by a control message manager 1335 as described with reference to FIG. 13.

At 1920, the method may include transmitting the message based on the control message. The operations of 1920 may be performed in accordance with examples as disclosed herein. In some examples, aspects of the operations of 1920 may be performed by a message manager 1340 as described with reference to FIG. 13.

At 1925, the method may include receiving feedback information for the message in accordance with the indicated first feedback process type. The operations of 1925 may be performed in accordance with examples as disclosed herein. In some examples, aspects of the operations of 1925 may be performed by a feedback manager 1345 as described with reference to FIG. 13.

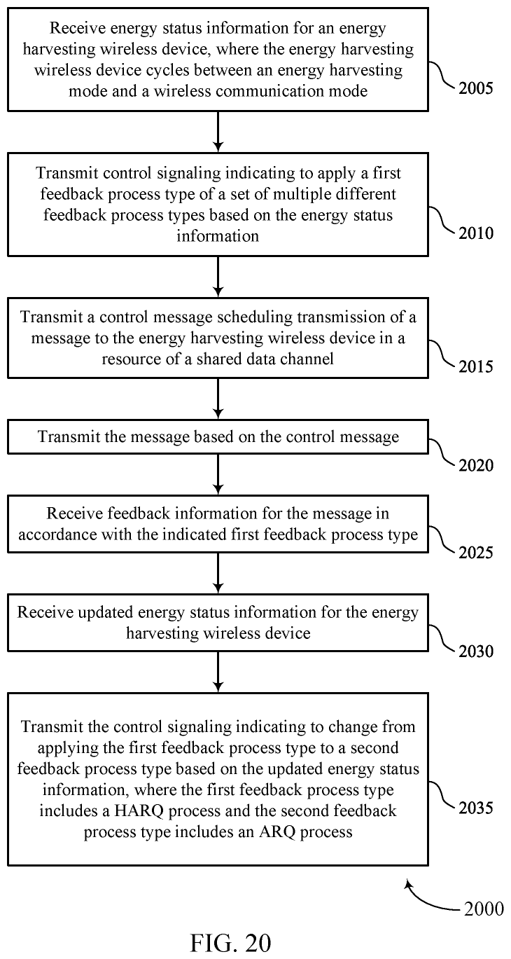

FIG. 20 illustrates a flowchart showing a method 2000 that supports feedback processes for energy harvesting devices in accordance with one or more aspects of the present disclosure. The operations of the method 2000 may be implemented by a network node or its components as described herein. For example, the operations of the method 2000 may be performed by a network node as described with reference to FIGS. 1 through 6 and 11 through 14. In some examples, a network node may execute a set of instructions to control the functional elements of the network node to perform the described functions. Additionally, or alternatively, the network node may perform aspects of the described functions using special-purpose hardware.

At 2005, the method may include receiving energy status information for an energy harvesting wireless device, where the energy harvesting wireless device cycles between an energy harvesting mode and a wireless communication mode. The operations of 2005 may be performed in accordance with examples as disclosed herein. In some examples, aspects of the operations of 2005 may be performed by an energy status manager 1325 as described with reference to FIG. 13.

At 2010, the method may include transmitting control signaling indicating to apply a first feedback process type of a set of multiple different feedback process types based on the energy status information. The operations of 2010 may be performed in accordance with examples as disclosed herein. In some examples, aspects of the operations of 2010 may be performed by a feedback process manager 1330 as described with reference to FIG. 13.

At 2015, the method may include transmitting a control message scheduling transmission of a message to the energy harvesting wireless device in a resource of a shared data channel. The operations of 2015 may be performed in accordance with examples as disclosed herein. In some examples, aspects of the operations of 2015 may be performed by a control message manager 1335 as described with reference to FIG. 13.

At 2020, the method may include transmitting the message based on the control message. The operations of 2020 may be performed in accordance with examples as disclosed herein. In some examples, aspects of the operations of 2020 may be performed by a message manager 1340 as described with reference to FIG. 13.

At 2025, the method may include receiving feedback information for the message in accordance with the indicated first feedback process type. The operations of 2025 may be performed in accordance with examples as disclosed herein. In some examples, aspects of the operations of 2025 may be performed by a feedback manager 1345 as described with reference to FIG. 13.

At 2030, the method may include receiving updated energy status information for the energy harvesting wireless device. The operations of 2030 may be performed in accordance with examples as disclosed herein. In some examples, aspects of the operations of 2030 may be performed by an energy status manager 1325 as described with reference to FIG. 13.

At 2035, the method may include transmitting the control signaling indicating to change from applying the first feedback process type to a second feedback process type based on the updated energy status information, where the first feedback process type includes a HARQ process and the second feedback process type includes an ARQ process. The operations of 2035 may be performed in accordance with examples as disclosed herein. In some examples, aspects of the operations of 2035 may be performed by a feedback process manager 1330 as described with reference to FIG. 13.

The following provides an overview of aspects of the present disclosure:

Aspect 1: A method for wireless communication at an energy harvesting wireless device, comprising: transmitting energy status information for the energy harvesting wireless device, wherein the energy harvesting wireless device cycles between an energy harvesting mode and a wireless communication mode: receiving, during the wireless communication mode, control signaling indicating to apply a first feedback process type of a plurality of different feedback process types based at least in part on the energy status information: receiving a control message scheduling transmission of a message to the energy harvesting wireless device in a resource of a shared data channel: monitoring the resource for the message based at least in part on the control message: and transmitting feedback information for the message in accordance with the indicated first feedback process type.

Aspect 2: The method of aspect 1, further comprising: transmitting updated energy status information for the energy harvesting wireless device: and receiving the control signaling indicating to change from applying the first feedback process type to a second feedback process type based at least in part on the updated energy status information, wherein the first feedback process type comprises a HARQ process and the second feedback process type comprises an ARQ process.

Aspect 3: The method of any of aspects 1 through 2, further comprising: transmitting a report indicating a quantity of HARQ processes supported by the energy harvesting wireless device, wherein the quantity of HARQ processes indicates the first feedback process type.

Aspect 4: The method of aspect 3, wherein the report indicates a maximum quantity of HARQ processes.

Aspect 5: The method of any of aspects 1 through 4, further comprising: monitoring for a retransmission of the message based at least in part on an expiration of an RTT timer.

Aspect 6: The method of any of aspects 1 through 5, further comprising: receiving a low-power signal indicating a change to an RTT timer, a retransmission timer, or both.

Aspect 7: The method of any of aspects 1 through 6, further comprising: transmitting a message indicating a plurality of RTT timers, wherein an RTT timer of the plurality of RRT timers is based at least in part on the energy status information.

Aspect 8: The method of any of aspects 1 through 7, further comprising: starting an RTT timer based at least in part on transmitting the feedback information, wherein a duration of the RTT timer is based at least in part on the energy status information.

Aspect 9: The method of any of aspects 1 through 8, further comprising: monitoring a control channel for receiving a retransmission of the message during a duration of a retransmission timer: performing energy harvesting during the duration of the retransmission timer and based at least in part on entering an energy harvesting mode: and suspending the retransmission timer based at least in part on entering the energy harvesting mode.

Aspect 10: The method of any of aspects 1 through 9, wherein receiving the control signaling comprises: receiving the control signaling indicating a quantity of HARQ processes based at least in part on the energy status information.

Aspect 11: The method of any of aspects 1 through 10, further comprising: receiving a request to increase a quantity of HARQ processes based at least in part on the energy status information.

Aspect 12: The method of any of aspects 1 through 11, wherein the feedback information indicates one or more symbols of the message the energy harvesting wireless device failed to receive, and wherein the method further comprises: receiving a second control message that indicates a HARQ process and the one or more symbols based at least in part on the feedback information.

Aspect 13: The method of aspect 12, wherein receiving the second control message comprises: receiving the second control message that indicates a bitmap, wherein the bitmap indicates the one or more symbols.

Aspect 14: The method of any of aspects 1 through 13, wherein transmitting the energy status information comprises: transmitting the energy status information indicating that the energy harvesting wireless device corresponds to a class of wireless devices that support energy harvesting.

Aspect 15: The method of any of aspects 1 through 14, wherein the energy status information comprises an energy status profile, a charging rate profile, a discharging rate profile, a battery leakage rate profile, or a combination thereof.

Aspect 16: A method for wireless communication at a network node, comprising: receiving energy status information for an energy harvesting wireless device, wherein the energy harvesting wireless device cycles between an energy harvesting mode and a wireless communication mode: transmitting control signaling indicating to apply a first feedback process type of a plurality of different feedback process types based at least in part on the energy status information: transmitting a control message scheduling transmission of a message to the energy harvesting wireless device in a resource of a shared data channel: transmitting the message based at least in part on the control message: and receiving feedback information for the message in accordance with the indicated first feedback process type.

Aspect 17: The method of aspect 16, further comprising: receiving updated energy status information for the energy harvesting wireless device: and transmitting the control signaling indicating to change from applying the first feedback process type to a second feedback process type based at least in part on the updated energy status information, wherein the first feedback process type comprises a HARQ process and the second feedback process type comprises an ARQ process.

Aspect 18: The method of any of aspects 16 through 17, further comprising: receiving a report indicating a quantity of HARQ processes supported by the energy harvesting wireless device, wherein the quantity of HARQ processes indicates the first feedback process type.

Aspect 19: The method of aspect 18, wherein the report indicates a maximum quantity of HARQ processes.

Aspect 20: The method of any of aspects 16 through 19, further comprising: transmitting a retransmission of the message based at least in part on an expiration of an RTT timer.

Aspect 21: The method of any of aspects 16 through 20, further comprising: transmitting a low-power signal indicating a change to an RTT timer, a retransmission timer, or both.

Aspect 22: The method of any of aspects 16 through 21, further comprising: receiving a message indicating a plurality of RTT timers, wherein an RTT timer of the plurality of RTT timers is based at least in part on the energy status information.

Aspect 23: The method of any of aspects 16 through 22, further comprising: starting an RTT timer based at least in part on transmitting the feedback information, wherein a duration of the RTT timer is based at least in part on the energy status information.

Aspect 24: The method of any of aspects 16 through 23, further comprising: transmitting a retransmission of the message via a control channel during a duration of a retransmission timer; and suspending the retransmission timer based at least in part on the energy harvesting wireless device entering an energy harvesting mode.

Aspect 25: The method of any of aspects 16 through 24, wherein transmitting the control signaling comprises: transmitting the control signaling indicating a quantity of HARQ processes based at least in part on the energy status information.

Aspect 26: The method of any of aspects 16 through 25, further comprising: transmitting a request to increase a quantity of HARQ processes based at least in part on the energy status information.

Aspect 27: The method of any of aspects 16 through 26, wherein the feedback information indicates one or more symbols of the message the energy harvesting wireless device failed to receive, and wherein the method further comprises: transmitting a second control message that indicates a HARQ process and the one or more symbols based at least in part on the feedback information.

Aspect 28: The method of aspect 27, wherein transmitting the second control message comprises: transmitting the second control message that indicates a bitmap, wherein the bitmap indicates the one or more symbols.

Aspect 29: The method of any of aspects 27 through 28, further comprising: rescheduling transmission of the one or more symbols that the energy harvesting wireless device failed to receive.

Aspect 30: The method of any of aspects 16 through 29, wherein receiving the energy status information comprises: receiving the energy status information indicating that the energy harvesting wireless device corresponds to a class of wireless devices that support energy harvesting.

Aspect 31: The method of any of aspects 16 through 30, wherein the energy status information comprises an energy status profile, a charging rate profile, a discharging rate profile, a battery leakage rate profile, or a combination thereof.

Aspect 32: An apparatus for wireless communication at an energy harvesting wireless device, comprising a processor; memory coupled with the processor; and instructions stored in the memory and executable by the processor to cause the apparatus to perform a method of any of aspects 1 through 15.

Aspect 33: An apparatus for wireless communication at an energy harvesting wireless device, comprising at least one means for performing a method of any of aspects 1 through 15.

Aspect 34: A non-transitory computer-readable medium storing code for wireless communication at an energy harvesting wireless device, the code comprising instructions executable by a processor to perform a method of any of aspects 1 through 15.

Aspect 35: An apparatus for wireless communication at a network node, comprising a processor: memory coupled with the processor; and instructions stored in the memory and executable by the processor to cause the apparatus to perform a method of any of aspects 16 through 31.

Aspect 36: An apparatus for wireless communication at a network node, comprising at least one means for performing a method of any of aspects 16 through 31.

Aspect 37: A non-transitory computer-readable medium storing code for wireless communication at a network node, the code comprising instructions executable by a processor to perform a method of any of aspects 16 through 31.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at an energy harvesting wireless device, comprising:
a processor;
memory coupled with the processor; and
instructions stored in the memory and executable by the processor to cause the apparatus to:
transmit energy status information for the energy harvesting wireless device, wherein the energy harvesting wireless device cycles between an energy harvesting mode and a wireless communication mode;
receive, during the wireless communication mode, control signaling indicating to apply a first feedback process type of a plurality of different feedback process types based at least in part on the energy status information:
receive a control message scheduling transmission of a message to the energy harvesting wireless device in a resource of a shared data channel;
monitor the resource for the message based at least in part on the control message; and
transmit feedback information for the message in accordance with the indicated first feedback process type.

2. The apparatus of claim 1, wherein the instructions are further executable by the processor to:
transmit updated energy status information for the energy harvesting wireless device; and
receive the control signaling indicating to change from applying the first feedback process type to a second feedback process type based at least in part on the updated energy status information, wherein the first feedback process type comprises a hybrid automatic repeat request process and the second feedback process type comprises an automatic repeat request process.

3. The apparatus of claim 1, wherein the instructions are further executable by the processor to:
transmit a report indicating a quantity of hybrid automatic repeat request processes supported by the energy harvesting wireless device, wherein the quantity of hybrid automatic repeat request processes indicates the first feedback process type.

4. The apparatus of claim 3, wherein the report indicates a maximum quantity of hybrid automatic repeat request processes.

5. The apparatus of claim 1, wherein the instructions are further executable by the processor to:
monitor for a retransmission of the message based at least in part on an expiration of a round trip time timer.

6. The apparatus of claim 1, wherein the instructions are further executable by the processor to:
receive a low-power signal indicating a change to a round trip time timer, a retransmission timer, or both.

7. The apparatus of claim 6, wherein the instructions are further executable by the processor to:
receive capability signaling indicating a capability to support the change to the round trip time timer, the retransmission timer, or both.

8. The apparatus of claim 1, wherein the instructions are further executable by the processor to:
transmit a message indicating a plurality of round trip time timers, wherein a round trip time timer of the plurality of round trip time timers is based at least in part on the energy status information.

9. The apparatus of claim 1, wherein the instructions are further executable by the processor to:
start a round trip time timer based at least in part on transmitting the feedback information, wherein a duration of the round trip time timer is based at least in part on the energy status information.

10. The apparatus of claim 1, wherein the instructions are further executable by the processor to:
monitor a control channel for receiving a retransmission of the message during a duration of a retransmission timer;
perform energy harvesting during the duration of the retransmission timer and based at least in part on entering the energy harvesting mode; and
suspend the retransmission timer based at least in part on entering the energy harvesting mode.

11. The apparatus of claim 1, wherein the instructions are further executable by the processor to receive the control signaling by being executable by the processor to:
receive the control signaling indicating a quantity of hybrid automatic repeat request processes based at least in part on the energy status information.

12. The apparatus of claim 1, wherein the instructions are further executable by the processor to:
receive a request to increase a quantity of hybrid automatic repeat request processes based at least in part on the energy status information.

13. The apparatus of claim 1, wherein the feedback information indicates one or more symbols of the message the energy harvesting wireless device failed to receive, and the instructions are further executable by the processor to:
receive a second control message that indicates a hybrid automatic repeat request process and the one or more symbols based at least in part on the feedback information.

14. The apparatus of claim 13, wherein the instructions are further executable by the processor to receive the second control message by being executable by the processor to:
receive the second control message that indicates a bitmap, wherein the bitmap indicates the one or more symbols.

15. The apparatus of claim 1, wherein the instructions are further executable by the processor to transmit the energy status information by being executable by the processor to:
transmit the energy status information indicating that the energy harvesting wireless device corresponds to a class of wireless devices that support energy harvesting.

16. The apparatus of claim 1, wherein the energy status information comprises an energy status profile, a charging rate profile, a discharging rate profile, a battery leakage rate profile, or a combination thereof.

17. An apparatus for wireless communication at a network node, comprising:
a processor;
memory coupled with the processor; and
instructions stored in the memory and executable by the processor to cause the apparatus to:
receive energy status information for an energy harvesting wireless device, wherein the energy harvesting wireless device cycles between an energy harvesting mode and a wireless communication mode;
transmit control signaling indicating to apply a first feedback process type of a plurality of different feedback process types based at least in part on the energy status information;
transmit a control message scheduling transmission of a message to the energy harvesting wireless device in a resource of a shared data channel;
transmit the message based at least in part on the control message; and
receive feedback information for the message in accordance with the indicated first feedback process type.

18. The apparatus of claim 17, wherein the instructions are further executable by the processor to:
receive updated energy status information for the energy harvesting wireless device; and
transmit the control signaling indicating to change from applying the first feedback process type to a second feedback process type based at least in part on the updated energy status information, wherein the first feedback process type comprises a hybrid automatic repeat request process and the second feedback process type comprises an automatic repeat request process.

19. The apparatus of claim 17, wherein the instructions are further executable by the processor to:
receive a report indicating a quantity of hybrid automatic repeat request processes supported by the energy harvesting wireless device, wherein the quantity of hybrid automatic repeat request processes indicates the first feedback process type.

20. The apparatus of claim 19, wherein the report indicates a maximum quantity of hybrid automatic repeat request processes.

21. The apparatus of claim 17, wherein the instructions are further executable by the processor to:
transmit a retransmission of the message based at least in part on an expiration of a round trip time timer.

22. The apparatus of claim 17, wherein the instructions are further executable by the processor to:
transmit a low-power signal indicating a change to a round trip time timer, a retransmission timer, or both.

23. The apparatus of claim 22, wherein the instructions are further executable by the processor to:
transmit capability signaling indicating a capability to support the change to the round trip time timer, the retransmission timer, or both.

24. The apparatus of claim 17, wherein the instructions are further executable by the processor to:
receive a message indicating a plurality of round trip time timers, wherein a round trip time timer of the plurality of round trip time timers is based at least in part on the energy status information.

25. The apparatus of claim 17, wherein the instructions are further executable by the processor to:
start a round trip time timer based at least in part on transmitting the feedback information, wherein a duration of the round trip time timer is based at least in part on the energy status information.

26. The apparatus of claim 17, wherein the instructions are further executable by the processor to:
transmit a retransmission of the message via a control channel during a duration of a retransmission timer; and
suspend the retransmission timer based at least in part on the energy harvesting wireless device entering the energy harvesting mode.

27. The apparatus of claim 17, wherein the instructions are further executable by the processor to transmit the control signaling by being executable by the processor to:
transmit the control signaling indicating a quantity of hybrid automatic repeat request processes based at least in part on the energy status information.

28. The apparatus of claim 17, wherein the instructions are further executable by the processor to:
transmit a request to increase a quantity of hybrid automatic repeat request processes based at least in part on the energy status information.

29. A method for wireless communication at an energy harvesting wireless device, comprising:
transmitting energy status information for the energy harvesting wireless device, wherein the energy harvesting wireless device cycles between an energy harvesting mode and a wireless communication mode;
receiving, during the wireless communication mode, control signaling indicating to apply a first feedback process type of a plurality of different feedback process types based at least in part on the energy status information;
receiving a control message scheduling transmission of a message to the energy harvesting wireless device in a resource of a shared data channel;
monitoring the resource for the message based at least in part on the control message; and
transmitting feedback information for the message in accordance with the indicated first feedback process type.

30. A method for wireless communication at a network node, comprising:
receiving energy status information for an energy harvesting wireless device, wherein the energy harvesting wireless device cycles between an energy harvesting mode and a wireless communication mode;
transmitting control signaling indicating to apply a first feedback process type of a plurality of different feedback process types based at least in part on the energy status information;
transmitting a control message scheduling transmission of a message to the energy harvesting wireless device in a resource of a shared data channel;
transmitting the message based at least in part on the control message; and
receiving feedback information for the message in accordance with the indicated first feedback process type.
